(19) United States
(12) Patent Application Publication
(10) Pub. No.: US 2007/0043582 A1
(43) Pub. Date: Feb. 22, 2007

(54) Method and system for providing customized footwear to a retail consumer

(75) Inventors: Mikal Peveto, Lanzago Di Silea (IT); Savino Bove, Montebelluna (IT); Jay White, Carlsbad, CA (US); Robert Erb, New York, NY (US); Nate Heckman, New York, NY (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FILA LUXEMBOURG S.A.R.L., Luxembourg (LU)

(21) Appl. No.: 11/365,612

(22) Filed: Mar. 2, 2006

Related U.S. Application Data
(60) Provisional application No. 60/709,792, filed on Aug. 22, 2005.

(51) Int. Cl. G06Q 99/00; G06Q 30/00

(52) U.S. Cl. 705/1; 705/26

(57) ABSTRACT

A method for providing a custom shoe to a consumer, including identifying at least one characteristic about a consumer that is present within the retail store, the at least one characteristic relating to the consumer's foot. Also included is selecting a plurality of pre-fabricated footwear components based on the at least one characteristic, assembling the plurality of prefabricated footwear components into a custom shoe that is customized to the consumer, and presenting the custom shoe to the consumer before the customer leaves the retail store.

### CROSS-REFERENCE TO RELATED APPLICATIONS

This application is related to and claims priority to U.S. Provisional Application Ser. No. 60/709,792, filed on Aug. 22, 2005, the entire content of which is incorporated herein by reference. This application is related to Attorney Docket No. 275482US titled ADAPTABLE SHOE HAVING AN EXPANDABLE SOLE ASSEMBLY, Attorney Docket No. 275483US titled METHOD AND SYSTEM FOR PROVIDING A CUSTOMIZED SHOE, and Attorney Docket No. 275487US titled MTHOD AND SYSTEM FOR IDENTIFYING A KIT OF FOOTWEAR COMPONENTS USED TO PROVIDE CUSTOMIZED FOOTWEAR TO A CONSUMER, each filed on even date herewith. The entire content of each of these applications is hereby incorporated herein by reference.

### BACKGROUND OF THE INVENTION

1. Field of the Invention

The present invention relates generally to a method and system for providing customized footwear to a consumer, and more specifically to a method and system for assembling a plurality of footwear components to provide a custom footwear product.

2. Discussion of Background

The past several decades have seen commoditization of the footwear industry. Indeed, economies of scale in mass manufacturing and distribution has brought the price of footwear down to such an extent that nearly all customers are conditioned to forgo their individual needs and settle for standardized—off the shelf—but extremely affordable footwear products. However, the uniqueness of individual customers still remains, and recent indicators of a move toward customization are present in the footwear industry.

For example, orthotics specially manufactured based on a person's anatomical foot dimensions are becoming more commonplace. The podiatric profession has long obtained anatomical foot dimensions by forming a plaster casting of a patient's foot. These plaster castings are then used to manufacture an orthotic that precisely corresponds to the dimensions of the plaster casting. However, the quality of the orthotic depends largely on the quality of the plaster casting, which varies widely due to variances in the technique of the physician or technician creating the casting. More recently, specialty retailers like Foot Solutions, Inc., use computer and sensory technology to electronically map the anatomical foot dimensions of a customer. An orthodic is then milled from bulk material in accordance with the electronic map of the customer's foot. While this technique provides an alternative to plaster castings, milling of an orthotic insole to precisely match the anatomical foot dimensions is still required. This special manufacturing leads to greater cost to the consumer, and a substantial delay in receiving the end product while manufacturing occurs. Moreover, orthotics that are unacceptable to the customer must be modified or re-manufactured, which leads to great delay and frustration of the consumer. Indeed, the impulsive nature of consumers and their need to test a product on demand may be a major impediment to wide-spread acceptance of specially manufactured orthotics.

A few shoe manufacturers have responded to the desire for customization by providing footwear sizing systems that offer more sizing options. For example, New Balance offers multiple widths ranging from AA to EEEE. The consumer simply tries on multiple widths until the desired fit is achieved. While sizing schemes offering smaller increments of variation may result in a better fit to some consumers, the variability is still largely limited to length and width dimensions. Moreover, this approach results in substantially greater cost to the consumer. For example, New Balance's sizing system provides complex and expensive issues of product forecasting, inventory control, auto-replenishment systems and product design. These factors often require product pricing that can exclude a large population of consumers.

A further indication of the trend toward customization has been the increase in off-the-shelf footwear inserts and supplements sold in grocery stores, shoe repair shops, mass merchants and pharmacies. For example, Dr. Scholl's, a division of Schering-Plough, has developed more than 1,000 foot-care products and reportedly has sales in excess of $159 million. By some estimates, the over the counter insert and supplement industry as a whole is grossing more than a half billion dollars annually. However, these over the counter solutions are generally selected by the consumer based on intuition of what product will meet their comfort needs. However, as the source of foot problems is often difficult to pinpoint and solutions may be subtle, a laymen's selection of an over the counter product without anatomical foot analysis often does not lead to the desired fit. Moreover, the over the counter solutions are not typically correlated to a particular shoe style, and therefore may not be compatible with particular shoe types. Despite their increase in popularity, over the counter solutions have not proven to provide a level of customization that appeals to a broad base of consumers.

### SUMMARY OF THE INVENTION

Accordingly, one object of the present invention is to address the above described and/or other problems in the footwear industry.

Another object of the present invention is to provide an adaptable footwear product that allows small increments of variability to the footwear consumer without the need for large inventories of shoes.

Yet another object of the present invention is to provide a custom shoe system that provides greater variability among functional components of a shoe.

Still another object of the present invention is to provide a custom shoe system that allows a custom shoe to be made in a reasonable time in a consumer setting.

These and other objects are achieved by providing a novel method for providing a custom shoe to a consumer, including identifying at least one characteristic about a consumer that is present within the retail store, the at least one characteristic relating to the consumer's foot. Also included is selecting a plurality of pre-fabricated footwear components based on the at least one characteristic, assembling the plurality of prefabricated footwear components into a custom shoe that is customized to the consumer, and presenting the custom shoe to the consumer before the customer leaves the retail store.

Another aspect of the invention includes method for providing a specialized orthotic, including identifying at least one characteristic about a consumer that is present within the retail store, the at least one characteristic relating to the consumer's foot. Also included is determining from the at least one characteristic that the consumer could benefit from a specialized orthotic, and referring the consumer to a predetermined orthotics specialist who can prepare the specialized orthotic.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an illustration of a custom shoe in accordance with one embodiment of the present invention;

FIGS. 2a through 2d show shoes having different shaped contour lines of the elastic portion in accordance with different embodiments of the present invention;

FIG. 3 is an exploded view showing an insole having rigid expansion components in relation to an adaptable sole assembly in accordance with an embodiment of the present invention;

FIGS. 4a and 4b show bottom planar and cross sectional views of a sole assembly in accordance with an embodiment of the present invention;

FIGS. 5a and 5b show bottom planar and cross sectional views of a sole assembly in accordance with another embodiment of the present invention;

FIGS. 6a and 6b show bottom planar and cross sectional views of a sole assembly in accordance with another embodiment of the present invention;

FIG. 7 shows an insole and sole assembly in relation to a plurality of footwear components, which can be assembled into a custom shoe in accordance with an embodiment with the present invention;

FIG. 8 shows an insole having various durometer hardness segments in accordance with an embodiment of the present invention;

FIGS. 9A and 9B show a bottom and medial side view respectively of an insole assembly in accordance with an embodiment of the present invention;

FIGS. 10A and 10B show a bottom and medial side view respectively of an insole assembly in accordance with another embodiment of the present invention;

FIG. 11 is a perspective view of a shoe having footwear components attached to the shoe upper in accordance with an embodiment of the present invention;

FIG. 12 shows a plurality of pre-manufactured arch supports that may be used to provide a custom shoe in accordance with the present invention;

FIG. 13 shows a plurality of pre-manufactured heel pads that may be used to provide a custom shoe in accordance with the present invention;

FIG. 14 is a flow chart of a process for providing customized footwear in accordance with an embodiment of the present invention;

FIG. 15 is a computerized system for providing customized footwear to a consumer in accordance with an embodiment of the present invention;

FIG. 16 shows a measuring station that may be used in accordance with an embodiment of the present invention;

FIG. 17 is an optical foot scanning device that may be used as the foot measuring device in accordance with an embodiment of the present invention;

FIG. 18 shows a measuring station that may be used in accordance with an embodiment of the present invention;

FIGS. 19a, 19b and 19c show data structures that may be used to provide a custom shoe in accordance with the present invention;

FIG. 20 is a flowchart explaining an in-store process for providing custom shoes in accordance with an embodiment of the present invention;

FIG. 21 illustrates a computer system upon which an embodiment according to the present invention may be implemented;

FIG. 22 is a flow chart of a computer process for obtaining information relating to a consumer's foot in accordance with an embodiment of the invention;

FIG. 23 is a flow chart of a computer process for determining a plurality of pre manufactured footwear components in accordance with an embodiment of the present invention; and

FIG. 24 is a flow chart of a process for assembling a custom footwear product in accordance with an embodiment of the present invention.

### DETAILED DESCRIPTION OF THE PREFERRED EMBODIMENTS

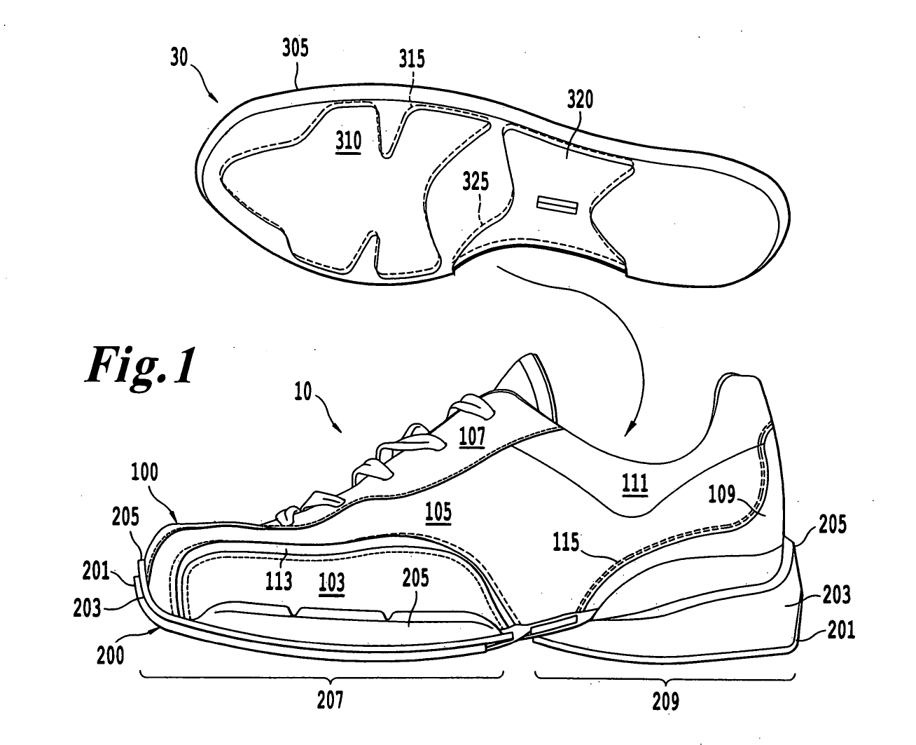

Referring now to the drawings, wherein like reference numerals designate identical or corresponding parts throughout the several views, FIG. 1 is an illustration of a custom shoe in accordance with one embodiment of the present invention. As seen in this figure, the shoe includes a shell 10 and an insole 30. The shell 10 includes an upper portion 100 and a sole assembly 200 that are joined to one another to form a shell cavity into which the insole 30 is placed, as depicted by the arrow in FIG. 1. The upper portion 100 includes upper segments 103, 105, 107, 109, 111 and 113 that are joined together to form the upper portion 100 as an integral unit. As seen in FIG. 1, the portions 103, 105, 107, 109 and 113 can be joined to their adjacent portions by stitching 115, but adhesive or other known joining methods may be used. The upper segments 103, 105, 107, 109 and 111 are preferably made of durable sheets of non-elastic material such as leather, canvas, synthetic material or any other upper material known in the art of shoes. In the embodiment of FIG. 1, however, the segment 113 connected between segments 103 and 105 is made of an elastic material such as a nylon mesh or any known flexible fabric. As used herein, the terms “elastic” and “non-elastic” are defined in the sense that a non-elastic material does not stretch when subjected to the same forces that would stretch the elastic material. Thus, in the embodiment of FIG. 1 the segments 103 and 105 can separate from one another to allow expansion and adaptability of the upper portion 100 when a foot is placed into the shoe.

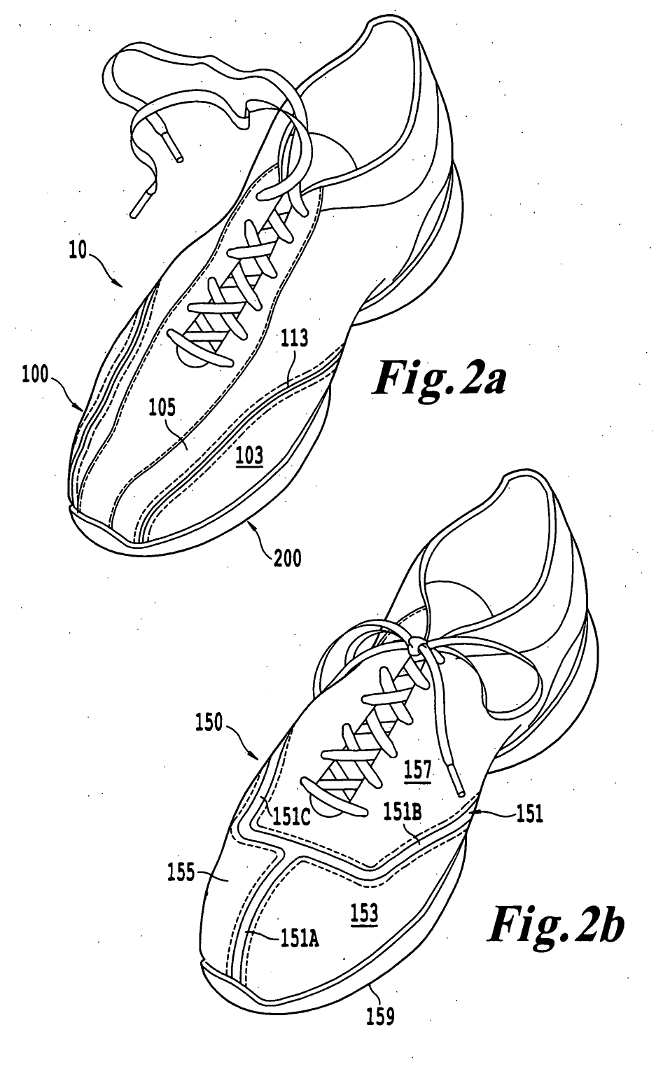

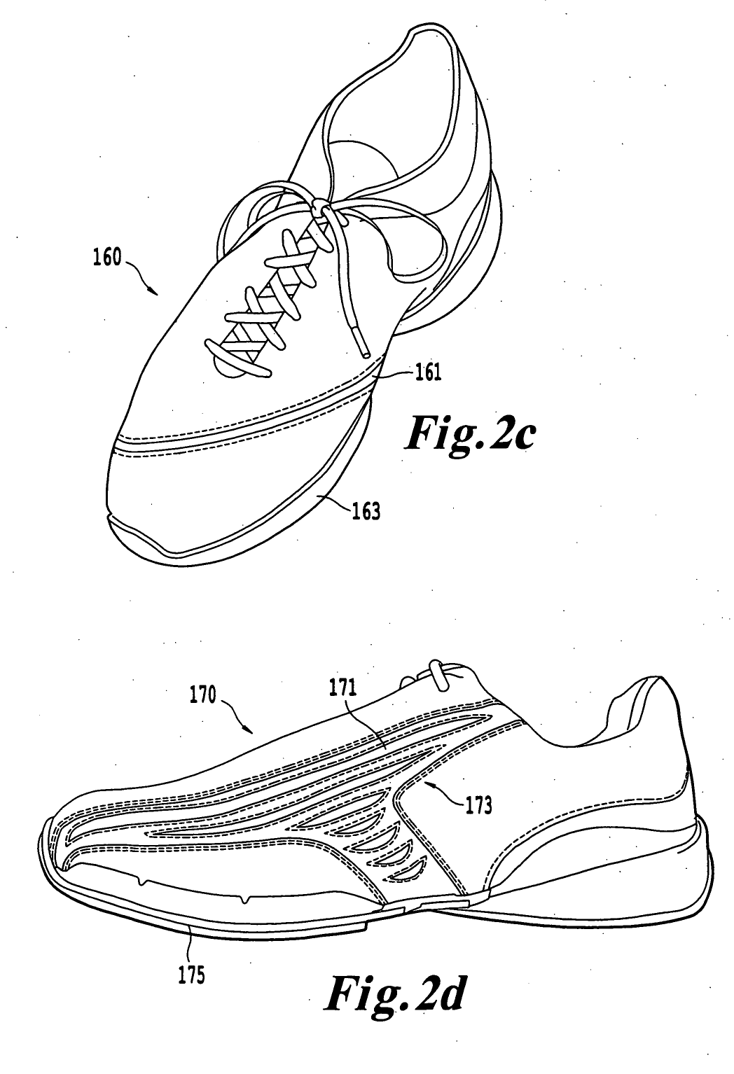

According to one aspect of the present invention, the elastic portion 113 is joined to upper segments to provide a predetermined contour line that is associated with a characteristic of the wearer. FIGS. 2a through 2d are perspective views of shoes having different shaped contour lines of the elastic portion 113 in accordance with different embodiments of the present invention. As seen in FIG. 2a, the shoe shell 10 includes the elastic portion 113 joining upper segments 103 and 105, as previously shown in the side view of FIG. 1. The contour line runs from a toe area on a front portion of the shoe, extending toward a heel area of the shoe terminating at a middle longitudinal part of the shoe to provide a substantially longitudinal contour line that allows expansion and adaptability of the shoe upper. As also seen in FIG. 2a, a longitudinal contour line is provided on both a medial and lateral side of the shoe. The present inventors have recognized this configuration of the longitudinal contour lines provides flexibility characteristics that are well suited for a walking shoe.

As seen in FIG. 2b, a shoe 150 includes an elastic portion 151 joining segments of the shoe upper. In this embodiment, the elastic portion 151 has a contour line shaped as a wishbone. Specifically, the elastic portion 151 includes a first part 151a that extends from a middle toe region of the sole assembly 159 to join segments 153 and 155. The elastic portion 151 then divides into separate parts 151b and 151c that extend from part 151a to lateral and medial sides of the shoe 150. In a preferred embodiment, the parts 151b and 151c terminate at opposing sides of the sole assembly 159 in a middle region of the shoe 150. The present inventors have recognized that such a wishbone contour line provides flexibility characteristics suitable for a running shoe.

As seen in FIG. 2c, a shoe 160 includes an elastic portion 161 joining segments of the shoe upper. In this embodiment, the elastic portion 161 has a contour line that begins at a toe region of the sole assembly 163 on a lateral side of the shoe 160, and traverses the upper portion of the shoe 160 to terminate at a middle region of the sole assembly 163 on a medial side of the shoe 160. The present inventors have discovered that such a transverse contour line provides flexibility characteristics suitable for a tennis shoe.

As seen in FIG. 2d, a shoe 170 includes a plurality of elastic portions 171 that extend longitudinally along the shoe 170 and are arranged in an array 173. In the embodiment of FIG. 2d, the elastic portions 171 at a top portion of the array 173 have a longer length than elastic portions at a bottom region of the array adjacent to the sole assembly 175. The present inventors have recognized that such an array contour line provides flexibility characteristics suitable for an all purpose shoe.

Thus, FIGS. 2a-2d show various contour shapes of the elastic upper segment, which provide different flexibility features that can be matched to a characteristic of the wearer, such as the intended use of the shoe. While the examples of FIGS. 2a-2d describe these contour lines as corresponding to the wearer characteristic of shoe use, other wearer characteristics such as age, weight or foot size, for example, may be a consideration in determining the contour lines.

As noted above, in one aspect of the present invention, a contour line of the flexible segment of the upper is selected in consideration of the activity that the wearer will use the shoe for (this may be considered a characteristic of the wearer). For example, the present inventors have recognized that the symmetry of motion during walking is front and back, and not much side to side in part due to the fairly even terrain encountered during walking. Therefore the contour line of a walking shoe described above is set to be very symmetrical across it.

Tennis, on the other hand, requires a great deal of left to right forces versus front to back, although both are done. Taking this into consideration, the flexible segment can be designed such that certain areas of the upper do not flex and get lose in the shoes. However, as one pivots and drives in tennis, the flexible segments can be arranged around the bony structure so that they always are holding your foot with a given amount of retention. For example, as the foot goes through these huge dynamic changes in tennis, the wearer's little toe gets pressed out because the foot is twisting on it. Most other shoes don't forgive in that area and the upper winds up being torn from the midsole. In one aspect of the present invention, the contour lines of the flexible segment can be tuned and placed to provide a little bit of stretch in this stress area so that the shoe is less likely to tear.

The above example is provided only for the contour lines of the flexible segment of the upper, however, this concept can be applied to other footwear components of the present invention, such as the deformable member discussed below. That is, key areas of the activity being performed such as propulsion, turning, torque, twisting, etc. may be considered for a given activity, and a footwear component can be matched to that activity. By providing a multiple component shoe, for example, the present invention can tune those key areas to the needs of the force by having them flex and contract in wanted areas or make sure certain areas do not flex and contract to put the foot in an adverse athletic or injury configuration because of the placement of those channels.

Returning to FIG. 1, the sole assembly 200 of shell 10 includes an outer sole 201, a middle sole 203 and sidewall portions 205. As shown by the brackets in FIG. 1, the sole assembly 200 includes a front section 207 for supporting a forefoot of the wearer's foot, and a back section 209 for supporting a heel of the wearer's foot. In the front and back sections of the sole assembly 200, the outer sole 201 is preferably implemented as a layer of deformable rubber material that contacts the ground when the shoe is in use. The outer sole also preferably includes treads that are designed to grip a variety of ground surfaces. In one embodiment, the outer sole 201 may be implemented as interchangeable tread segments uniquely designed for a particular ground surface or application, as will be further described below.

The middle sole 203 is provided in the front section 207 as a relatively thin layer of material having a substantially uniform thickness. This front section of the middle sole 203 is preferably a rigid but bendable layer of plastic material that supports the insole 30 when placed in the shoe, and provides a durable base for attachment of the outer sole 201. The middle sole 203 is provided in the back section 209 as a relatively thick contoured member. This back section of the middle sole 209 is preferably made of a foam material that provides rigidity as well as deformation properties to cushion the wearer's heel on impact during use. The sole assembly 200 also includes sidewalls 205 that extend upward from a plane formed by the middle sole so as to overlap toe, heel, and/or side surfaces of the upper portion 100 to reinforce a bottom region of the upper portion 200. In the embodiment of FIG. 1, sidewalls on the toe and heel region are provided by extending the middle sole 203 to wrap upwards onto the toe and heel regions. The sidewalls 205 are preferably made of a rigid material that substantially maintains its structural relationship to the sole assembly 200 when the sole assembly 200 is under stress.

In the embodiment of FIG. 1, the insole 30 includes main member 305, expansion member 310, and arch support 320. In the embodiment of FIG. 1, the main member 305 includes recesses 315 and 325 configured to receive expansion member 310 and arch support 320 respectively. The expansion member 310 and arch support 320 are shown fixed to their respective recesses, but these components may be separable from the shoe. The expansion member 310 and/or arch support 320 are preferably made of a rigid material that bends with the wearer's plantar region while the shoe is in use, but maintains length and width dimensions within the shoe cavity. In one embodiment rigid components, such as the expansion member 310 or arch support 320 of the insole 30, are used to expand width and/or length of a sole assembly in order to adapt the sole assembly to a particular wearer.

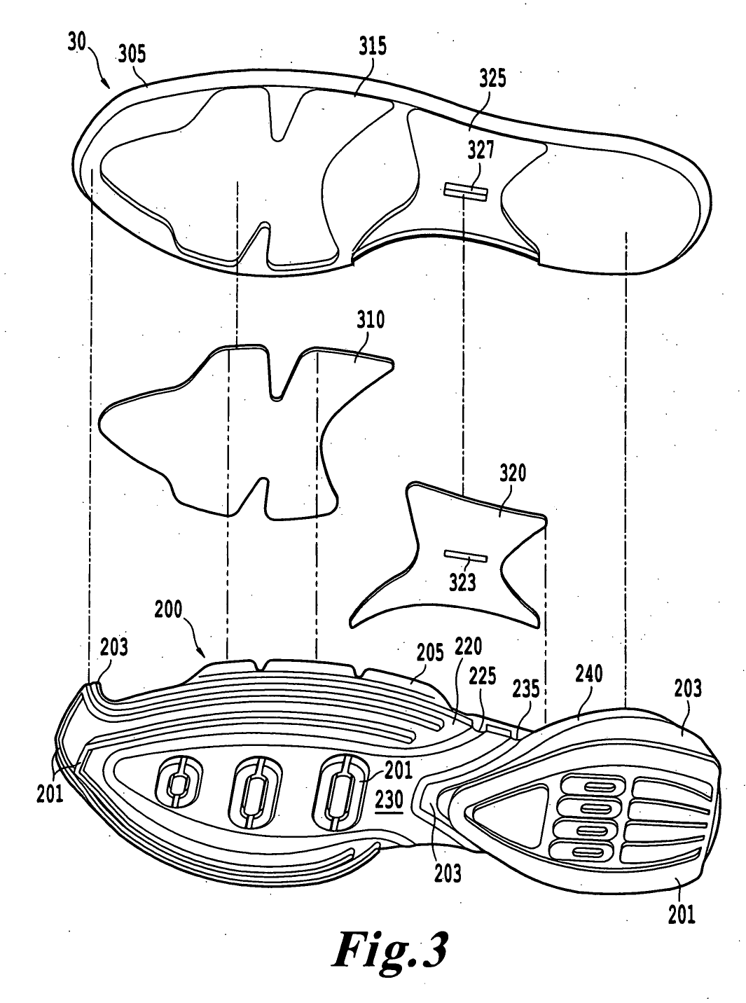

FIG. 3 is an exploded view showing an insole having rigid expansion components in relation to an adaptable sole assembly. In FIG. 3, the upper portion of the shoe is omitted for clarity. In the embodiment of FIG. 3, the expansion member 310 and arch support 320 are separable from the main member 305. Specifically the expansion member 310 fits within recess 315 and may be held therein by friction fit or adhesion, for example, although adhesion may permanently fix the expansion member 310 within the recess and prevent this component from being replaced. The arch support 320 includes an attachment aperture 323 that engages a tab 327 mounted within the recess 325 of the main portion 305. The aperture 323 and tab 327 allow the arch support 320 to be attached and detached from the main portion 305. As shown in FIG. 3, the expansion member 310 and arch support 325 extend across a full width of the insole 30 such that at least a portion of a side edge of these components provides an outward expansion force on sidewalls 205 of the sole assembly 200.

The sole assembly 200 includes outer sole portion 201 implemented as tread patterns mounted on a ground facing surface of the middle sole portion 203. The tread portions are configured to allow the sole assembly to grip the ground when the shoe is in use. As also seen in FIG. 3, the sole assembly 200 includes a first sole segment 220 and a second sole segment 230 joined to one another by a deformable member 225. The deformable member 225 allows the first and second sole segments 220 and 230 to move away from one another and expand the sole assembly 200 when an expansion force is applied to the sole assembly. Deformable member 235 similarly joins segments 230 and 240. As noted, the expansion force may be provided by a rigid member, such as the expansion member 310 and/or arch support 320 provided within the shoe. However, expansion may also be provided by the wearer's foot based on a size of the foot, or based on forces exerted on the insole during activities such as running or tennis. In this regard, a deformable member that extends in a line running in a longitudinal direction of the shoe will generally allow expansion of the sole assembly in a width direction, while a deformable member extending in a transverse line will generally allow expansion in a lengthwise direction of the shoe. The present inventors have recognized that a line of the deformable member can be contoured to optimize the expansion properties to a particular characteristic of the wearer, such as the sport in which the shoe will be used.

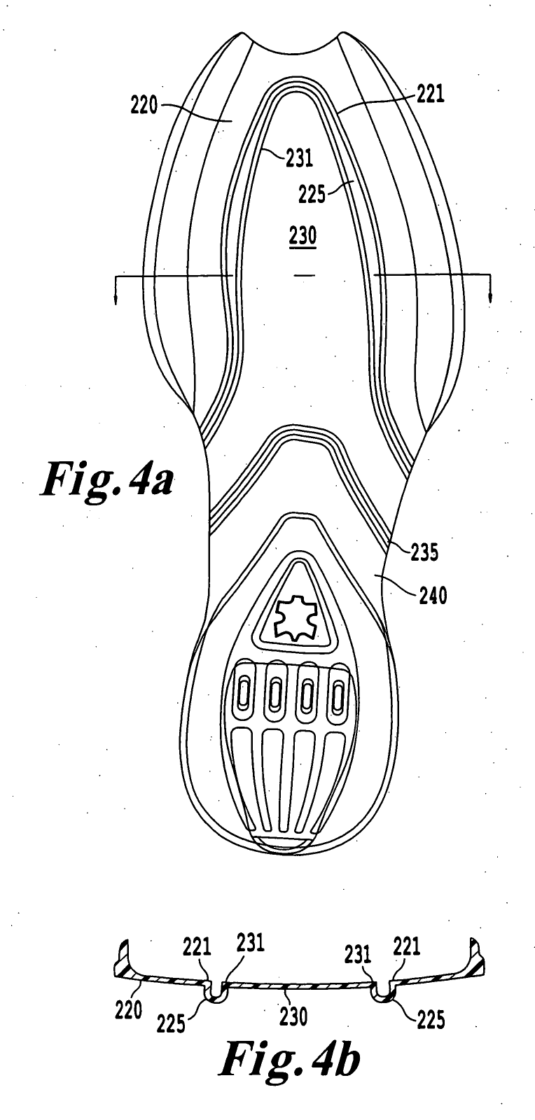

FIG. 4a is a bottom planar view showing contour lines of the deformable member in the sole assembly of FIG. 3. The outer sole portion 201 is omitted from a front region of the sole assembly for clarity. As seen in FIG. 4a, the sole assembly 200 is divided into a front segment 220, a middle segment 230 and a heel segment 240. These segments are preferably made of a substantially non-deformable material while deformable members 225 and 235 are made of a deformable material. As used herein, the terms “deformable” and “non-deformable” are used in the sense that a material is non-deformable if it does not undergo modification when subjected to those same forces that would deform the deformable material.

The front segment 220 has an elongated horseshoe shaped edge 221 that flares at its ends towards lateral and medial sides of the sole assembly 200. Middle segment 230 has an edge 231 substantially conforming to the edge 221, and deformable member 225 joins the edges 221 and 231 to one another. Thus, the deformable member 225 has a contour line that is an elongated horseshoe shape that terminates on opposing points of lateral and medial sides of the sole assembly 200. The deformable member 235 is shaped as a shortened horseshoe contour to similarly join middle segment 230 to heel segment 240. The present inventors have recognized that this configuration of deformable members is well suited to provide the expansion and adaptability suitable for a walking shoe.

As seen in cross-sectional FIG. 4b, the deformable member 225 is implemented as a U-shaped member, the ends of which are connected to segment 220 and segment 230. With this configuration, opposing outward forces applied to the segments 220 and 230 can cause the U-shaped member to flatten thereby allowing the segments 220 and 230 to move away from one another and expand the sole assembly in a width and length direction. In the embodiment of FIG. 4b, the U-shaped member is integral with the segments, 220 and 230, however, separate pieces may be used. For example, opposing ends of the U-shaped member may include flanges that mate with the segment edges 221 and 231. Moreover, the deformable member may be implemented in any known way for allowing the adjoining sole segments to move away from one another. Patent Application Serial Number PCT/IT 2005/000075, filed on Feb. 15, 2005, titled SHOE WITH ADJUSTABLE SOLE shows a variety of different configurations of the deformable member which may be used in accordance with the present invention. The entire content of this PCT Application is incorporated herein by reference.

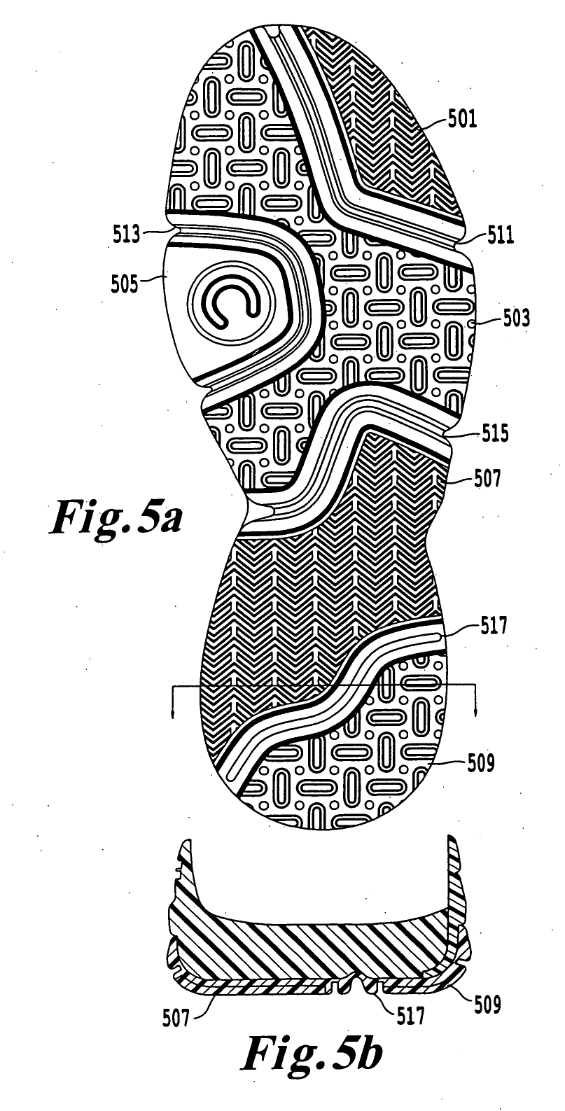

FIG. 5a is a bottom planar view showing contour lines of a deformable member of a sole assembly in accordance with another embodiment of the present invention. As seen in this figure, the sole assembly is divided into segments 501, 503, 505, 507 and 509 by a plurality of contour line deformable members. Deformable member 511 joins segments 501 and 503 along a contour running longitudinally from a toe portion to metatarsal region of the sole assembly, and extending in a transverse direction terminating on a lateral side of the sole assembly. Deformable member 513 joins segments 503 and 505 along a contour having a substantially hemispherical shape that surrounds the metatarsal ball area. Deformable members 515 and 517 run substantially in a transverse direction at a middle arch region and a heel region of the sole assembly respectively. As seen in cross-sectional FIG. 5b, the deformable member 517 is implemented as a bulging member that protrudes toward an interior of the shoe. The present inventors have recognized that the combination of contoured deformable members shown in FIG. 5a provides expansion and adaptability suitable for a tennis shoe.

As also seen in FIG. 5a, sole segments 501, 503, 505, 507 and 509 may have different tread types. The present inventors have recognized that varying tread types among sole segments can provide optimal grip for a given area of the sole assembly. Moreover, an optimal tread type may be different for different sports activities. In one embodiment, one or more treads of the different segments may be changed as will be described below.

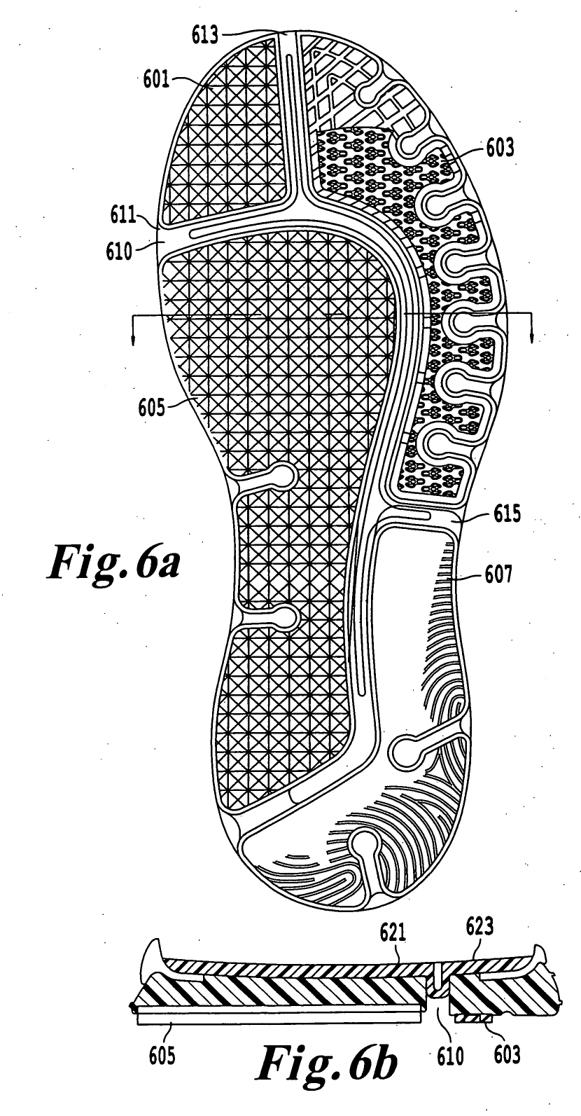

FIG. 6a is a bottom planar view showing contour lines of a deformable member of a sole assembly in accordance with another embodiment of the present invention. As seen in this figure, the sole assembly is divided into segments 601, 603, 605, and 607 by a continuous deformable member 610. The deformable member 610 includes a main branch 611 that joins segment 605 with each of segments 601, 603 and 607. Further, a substantially longitudinal branch 613 joins segments 601 and 603 at a toe region of the shoe, and a substantially transverse branch 615 joins segments 603 and 607 at a lateral middle region of the shoe. As seen in FIG. 6b, the deformable member 610 in the main branch region 611 is implemented as a U-shaped member having flanges 621 and 623 that are joined to laminated segments 603 and 605. The present inventors have recognized that the contoured deformable member shown in FIG. 6a provides expansion and adaptability suitable for a running shoe. As with the embodiment of FIG. 5a, the tread type may differ among segments as shown in FIG. 6A.

Thus, FIGS. 4a, 5a and 6a show different contours of the deformable member, which provide different expansion and adaptability features that can be matched to a characteristic of the wearer, such as the intended use of the shoe. While the examples of FIGS. 4a, 5a and 6a describe the different configurations of the deformable member as corresponding to the wearer characteristic of shoe use, other wearer characteristics such as age, weight or foot size, for example, may be considered in determining a configuration of the deformable member. As noted above, the contour line of a deformable member may be selected based on the activity of the wearer in a similar fashion as the contour of the flexible upper segment.

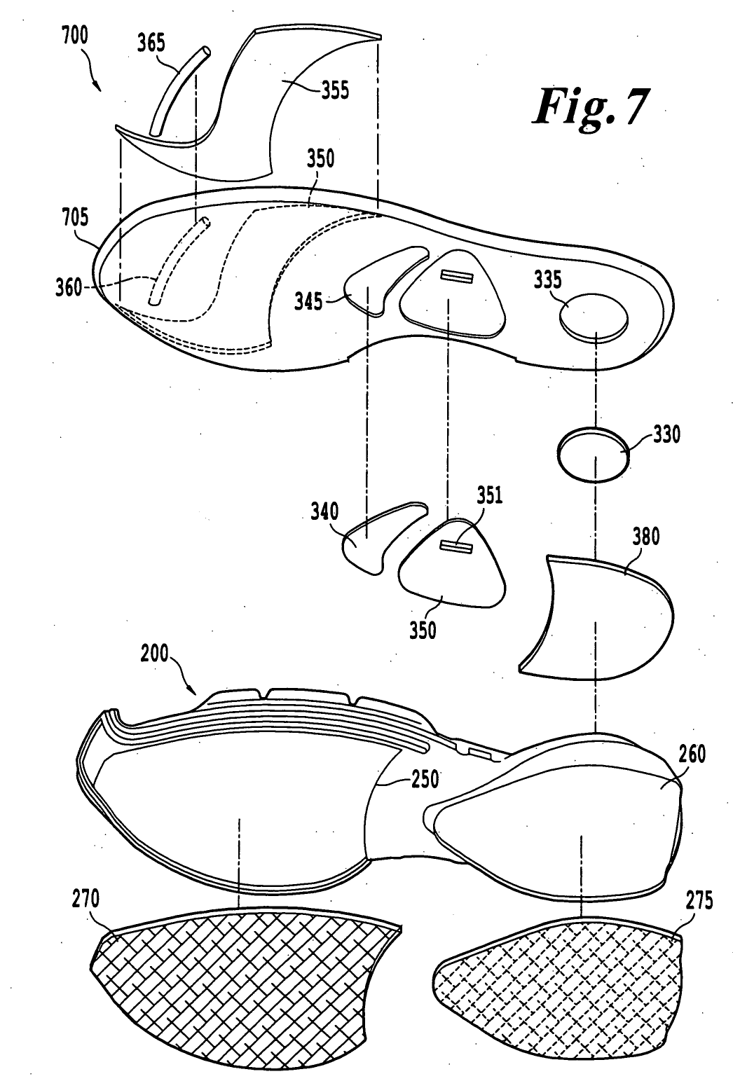

As discussed above, an insole may include footwear components such as an expansion member and arch support that allow length and width adaptability of a sole assembly in accordance with an embodiment of the present invention. However, the present inventors have recognized that such length and width adaptability alone may not provide the degree of customization desired by consumers. In accordance with one aspect of the present invention, a plurality of footwear components can be combined to provide a shoe customized for a particular person. FIG. 7 shows an insole and sole assembly in relation to a plurality of footwear components, which can be assembled into a custom shoe in accordance with an embodiment with the present invention.

As seen in FIG. 7, the insole 700 includes a main part 700 having a top surface that includes a recess 360 for accommodating a toe crest 365 and a recess 350 for accommodating a metatarsal head shelf 355. The toe crest 365 is shown as a tube running along the top surface of the digital sulcus area of a wearer's plantar region. The toe crest 365 relaxes the foot and allows a better toe grip to aid in propulsion, and can assist in buttressing hammer toe and mallet toe deformities. In a preferred embodiment, the toe crest 365 is a 3 millimeter diameter tube that is placed along digits two, three and four and tapers at the fifth digit of the wearer's foot. However different sizes and configurations of the toe crest may be used to accommodate a characteristic of the wearer. Moreover, the hardness of the toe crest may be varied in accordance with the needs of the wearer.

The metatarsal head pressure shelf 355 is a pad that extends transversely across the insole in a region of the metatarsal heads of the wearers foot. As seen in FIG. 7, the medial side of the shelf 355 advances towards the toes and the lateral side advances toward the heel. In a preferred embodiment, an axial center line of the metatarsal head pressure shelf 355 bisects a longitudinal center line of the insole to form an angle of approximately 74 degrees. This assures that the pressure shelf 355 is placed at a same angle as the metatarsal heads of most feet. The metatarsal head pressure shelf can function to improve first ray (medial cuniform—first Metatarsal and Hallux) stability, improve propulsion and reduce lesser metatarsal pressures. In one embodiment, the metatarsal head pressure shelf 355 is a constant relatively soft durometer which can improve reactive ground impact against the metatarsal heads. In another embodiment, the metatarsal head pressure shelf 355 can have a variable durometer hardness. In one example a graduated hardness is used across the fifth metatarsal phalangeal joint to the first metatarsal-phalangeal joint. This variable durometer pressure shelf will act as a functional forefoot varus wedge to improve propulsion and reduce pronation of the wearer's foot.

In still another embodiment, the metatarsal head pressure shelf 355 can be dimensioned as a mild varus wedge. In a preferred embodiment, the metatarsal pressure shelf 355 is approximately 2 millimeters higher at the first metatarsal head and tapers towards the fifth metatarsal head. This structure creates a wedge angle that tilts the wearer's foot towards the lateral side at initial impact, which reduces pronation of the foot. While the metatarsal head pressure shelf 355 is shown as an insert in a top surface of the main part 705, the metatarsal head pressure shelf may be implemented as an attachment to the bottom surface of the insole 700. In one embodiment, the expansion number 310 of FIG. 1 may be thicker on a medial side and taper towards a lateral side to provide the forefoot varus wedge discussed above.

In addition to the top surface components, insole 700 includes a metatarsal rise 340, arch support 350, heel insert 330 and heel clip 380 formed on a bottom surface of main part 705. As seen in FIG. 7, the metatarsal rise 340 is received within a recess 345 that is positioned rearward of the metatarsal head pressure shelf 355. The metatarsal rise 340 provides a slight bulge in a top surface of the insole 305. In accordance with an embodiment of the present invention, the metatarsal rise 340 is positioned at an apex of the proximal third metatarsal head to lift lesser metatarsal shafts and reduce pressure by improved weight bearing across the second, third and fourth metatarsal heads. This configuration can reduce metatarsalgia and neuroma symptoms. As with other footwear components, the size, shape and composition of the metatarsal rise 340 may be changed in accordance with the characteristic with the wearer.

Arch support 350 includes an aperture 351 that mates with tab 353 to attach the arch support 350 to the main part 705 of insole 700. Unlike the arch support 320 of FIGS. 1 and 3, the arch support 350 does not extend a full width of the insole 700 and therefore is not designed to expand the sole assembly as previously discussed. However, as with the arch support 320, the arch support 350 supports the longitudinal arch of the planter region to assist in reducing pronation of the foot on impact, and improves propulsion by selectively increasing arch height while acting to support the metatarsal joints and first ray during the midstance and propulsive phases of gait. As with arch support 320, proper selection of support 350 can result in less arch pain, longer standing, running and less injuries. In one embodiment of the present invention a size, shape, positioning and firmness of the arch supports 320 and 350 is selected in accordance with the characteristic of the wearer.

Heel insert 330 fits within recess 335. The insert 330 provides a soft durometer surface that reduces planter calcaneal burso and heel spur type syndromes, which are common. In one embodiment, heel spur accommodation may be implemented as a flared center hole in the heel seat of the main part 705. The heel insert 330 is designed to have a dual function. First, the insert can be left in member 705 as a default member to reduce pressure at the plantar calcaneous to assist in reducing minimal to moderate pressure. In addition, the 330 member can be removed to allow for moderate to high loading pressures. The heel spur accommodation is an excellent feature for golf and therapeutic walking. A size, shape and composition of the heel insert 330 and/or heel spur hole may be varied in accordance with characteristics of the wearer.

As also seen in FIG. 7, heel clip 380 is a substantially planar part that mounts to a bottom surface of the main part 705 in a heel area of the insole 700. The heel clip 380 is preferably a rigid material that traverses an entire width of the heel area of the insole 705. Thus, the heel clip 380 may be used to provide an outward force on sidewalls of the sole assembly to expand and adapt the sole assembly as previously discussed. In addition, the heel clip 380 is structured to provide an optional rear foot varus wedge to improve heel strike and help to alleviate heel pain syndromes. In one embodiment, the heel clip 380 is thicker in a medial region and tapers towards a lateral region of the heel to create a 2-3 degree varus wedge angle. This structure promotes lateral mass migration thus reducing rear foot and mid-foot pronation. While shown as a separate piece in FIG. 7, the rear foot varus wedge may be a pre-molded portion of the insole 305. In this embodiment, the durometer hardness of the rear foot varus wedge may be varied across a surface of the heel region.

Footwear components may also be attachable to the sole assembly 200. For example, the present inventors have recognized that different tread configurations may be preferable to accommodate different characteristics among wearers. In the embodiment of FIG. 7, a front tread segment 270 attaches to a tread area 250 of the sole assembly 200, while a rear tread segment 275 attaches to a tread region 260 of the sole assembly 200. These tread segments may be permanently attached to their respective tread areas of the sole assembly by adhesive, or may be separably attached using fasteners that are well known in the art of sports shoes. While FIG. 7 shows the tread as two portions, a single tread covering the bottom of the sole assembly 200 is possible, or multiple tread portions such as those discussed in FIGS. 5 and 6 may be used. As with other footwear components, the size, shape, location and material composition of the tread portions 270 and 275 can be changed to match a characteristic of the wearer. Tread portions 270 and 275 may be selected based on the type of sport (e.g., tennis, running, sailing etc.) different type of surface (e.g. tennis on grass versus asphalt), weight of the wearer (e.g. heavy people generally require less friction), age and/or playing ability, for example.

While FIG. 7 shows footwear components that are separable from the shoe structure, footwear components may me integrally formed with the shoe. For example, one or more of the footwear components shown attached to the insole 705 may be integrally formed with main part 705 of the insole 700. In this embodiment, interchangeable insoles can be pre-manufactured each with a different combination of footwear components integrally formed therein. For example, one insole may include an arch support, metatarsal head pressure shelf and metatarsal rise integrally formed therein and specifically designed to accommodate a heavy person, while a separate insole has these components integrally formed therein but specifically designed to accommodate a lighter person. In one embodiment, the insole may include a plurality of footwear components completely integrated therein, and separable components may be provided on the sole assembly or upper portion of the shoe. In another embodiment, the insole includes different durometer hardness regions integrally formed therein, while structural components such as arch support, heel clip and/or expansion number are attachable to the insole.

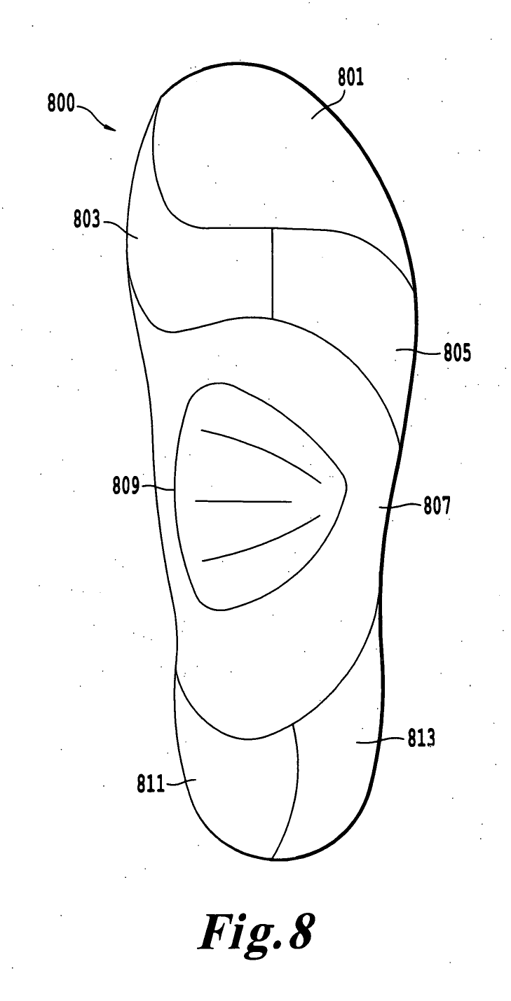

FIG. 8 shows an insole having biomechanically placed variable durometer hardness portions in accordance with an embodiment of the present invention. As seen in this figure, the insole 800 includes a toe portion 801, a medial metatarsal portion 803 and a lateral metatarsal portion 805. Also included is a middle foot portion 807 having a region 809 for receiving an arch support. A heel area of the insole 800 includes a medial heel portion 811 and a lateral heel portion 813. According to one embodiment, variable durometer hardness among these regions of the insole can provide pressure gradients that maximize foot comfort and relief of symptoms by focusing on the ergonomics of foot function. For example, the medial metatarsal phalangeal region 803 can provide a greater durometer hardness than the lateral metatarsal region 805. Similarly, the medial heel portion 811 can provide a greater durometer hardness than the lateral heel portion 813. Such a change in durometer hardness would enable the first and second rays to better resist pronation during the midstance phase of gait and better assist in the propulsion of weight transfer during the propulsive phase of gait. This configuration provides a pressure gradient that minimizes pronation of the foot upon impact. The toe portion 801 and the middle foot portion 807 may also include suitable durometer hardnesses, and the area 809 may be specifically configured to receive an arch support. Adding a higher durometer hardness in element 801 improves digital propulsion while in 807 it helps to support the arch and resist pronation.

In accordance with one embodiment of the invention, portions of the insole can be configured to adapt to the wearer's foot. For example, PCT Application No. PCT/IT2005/000071 filed on Feb. 14, 2005 and titled “SHOE HAVING AN INNER ADAPTABLE SURFACE ON WHICH THE WEARER'S FOOT RESTS” discloses a shoe sole having a first container containing a first reagent material comprising one phase of a two phase resin foam product and a second container containing a second reagent material defining the second phase of the two-phase synthetic resin foam product. The second region preferably fits within a void or depressed area defined within the first container such that when the second container breaks under pressure, the second phase reagent material mixes with the first reagent material to cure the resin foam product to a contour of the wearer's foot. The entire content of PCT/IT2005/000071 is incorporated herein by reference. Alternatively, the adaptable surface can be implements as microbeads or chambers containing reagents for curing a resin.

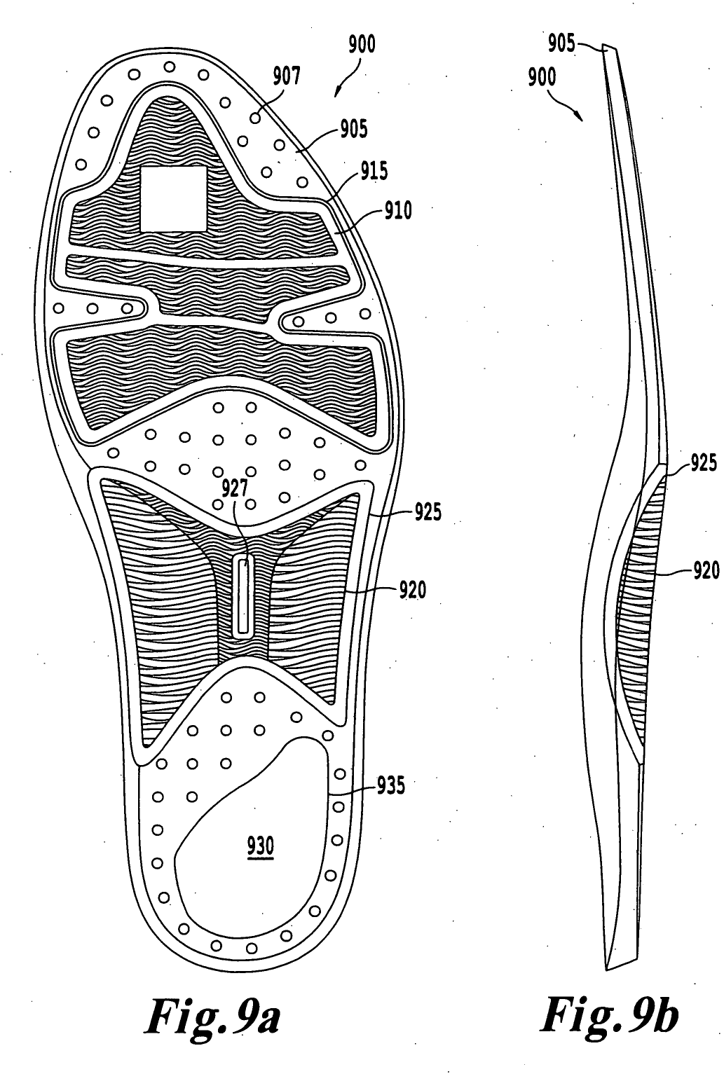

FIGS. 9a and 9b show bottom and medial side views respectively of an insole assembly in accordance with an embodiment of the present invention. As seen in these figures, the insole assembly 900 includes a main part 905 having dimples 907 formed therein. The main part 905 is preferably a foam material configured to aid in cushioning the wearer's foot upon impact, and also serves as a core to which footwear components are attached. The insole assembly of FIGS. 9a and 9b includes an expansion member 910 that is provided within a recess 915 on the main member 905. The expansion member 910 may be permanently fixed to the recess 915 by adhesives, or may be separably attached to recess 915 by a friction fit or other suitable attachment mechanisms. As noted with respect to FIG. 1, the expansion member 910 is a rigid member that can provide expansion and adaptability of a sole assembly in accordance with an embodiment of the present invention.

The insole assembly 900 also includes an arch support 920 provided within a recess 925 in the main part 905. The arch support 920 is attached to the main part 905 by way of attachment tab 927. As best seen in FIG. 9b, the arch support 920 is shaped in correspondence to a longitudinal arch of planter region of a wearer's foot. As previously discussed, the arch support is made of a rigid material to support the wearer's longitudinal arch, and may also function to expand a sole assembly in a width direction in accordance with an embodiment of the invention. The main part 905 includes a heel pad 930 provided within a recess 935 in the main part 905. The heel pad 930 provides a soft cushioning surface for the wearer's heel upon impact.

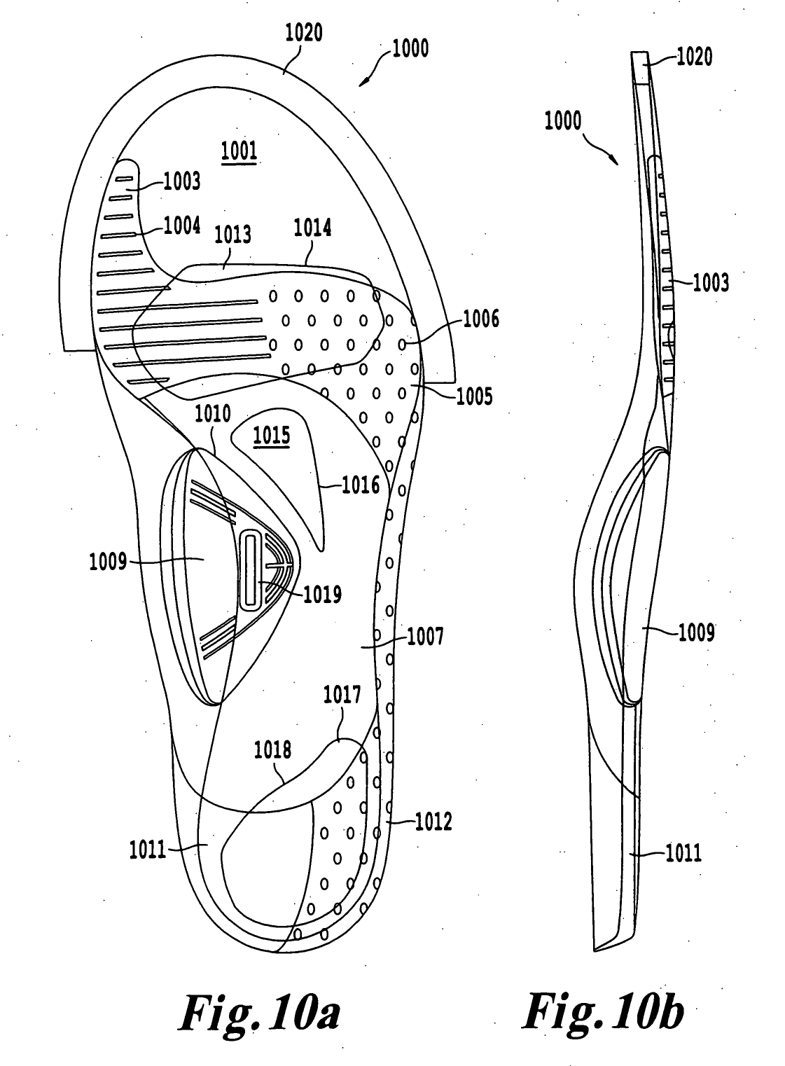

FIGS. 10a and 10b show bottom and medial side views respectively of an insole assembly in accordance with another embodiment of the present invention. As seen in these figures, a main part of the insole assembly 1000 includes multiple regions similar to the embodiment discussed with respect to FIG. 8. Specifically, the main part includes a toe portion 1001, a medial metatarsal portion 1003, a lateral metatarsal portion 1005, a middle foot portion 1007, an arch support portion 1009, a medial heel portion 1011, and a lateral heel portion 1012. In the embodiment of FIGS. 10a and 10b, these portions of the main part of the sole assembly 1000 have different configurations, material compositions and/or durometer hardnesses to accommodate a characteristic of the wearer. For example, the medial metatarsal portion 1003 includes grooves 1004 that provide a particular impact response, while the lateral metatarsal portion 1005 includes dimples 1006 that may provide a different impact response. Similarly, the medial heel portion 1011 does not include structural features while the lateral heel portions 1012 includes the dimples 1006.

In addition to the various portions of the main part, the sole assembly 1000 includes an arch support 1009 provided within recess 1010 of the main part. Attachment of the arch support is provided by tab 1019. As shown in FIG. 10b, the arch support is shaped to correspond to a longitudinal arch of the wearer to support the wearer's arch upon impact. However, the arch support 1009 does not extend across the entire width of the insole assembly 1000 and therefore does not provide significant expansion of a sole assembly.

Also included in the insole assembly 1000 is a metatarsal pad 1013 provided within a recess 1014. The metatarsal pad 1013 provides cushioning to the metatarsal heads and may be provided with a gradient durometer hardness as previously discussed. The metatarsal pad 1013 is shown as transparent in order to demonstrate the differences between the medial and lateral metatarsal regions 1003 and 1005 respectively. A metatarsal rise 1015 is also provided within a recess 1016 of the sole main part. The metatarsal rise 1015 provides a bulge in a top surface of the sole assembly as previously discussed. Finally, heel pad 1017 is provided within a recess 1018 of the main part 1001 in order to cushion heel impact during use. The metatarsal pad, the heel pad 1018 is shown transparent in order to demonstrate the characteristics of the medial and lateral portions of the heel 1011 and 1012 respectively.

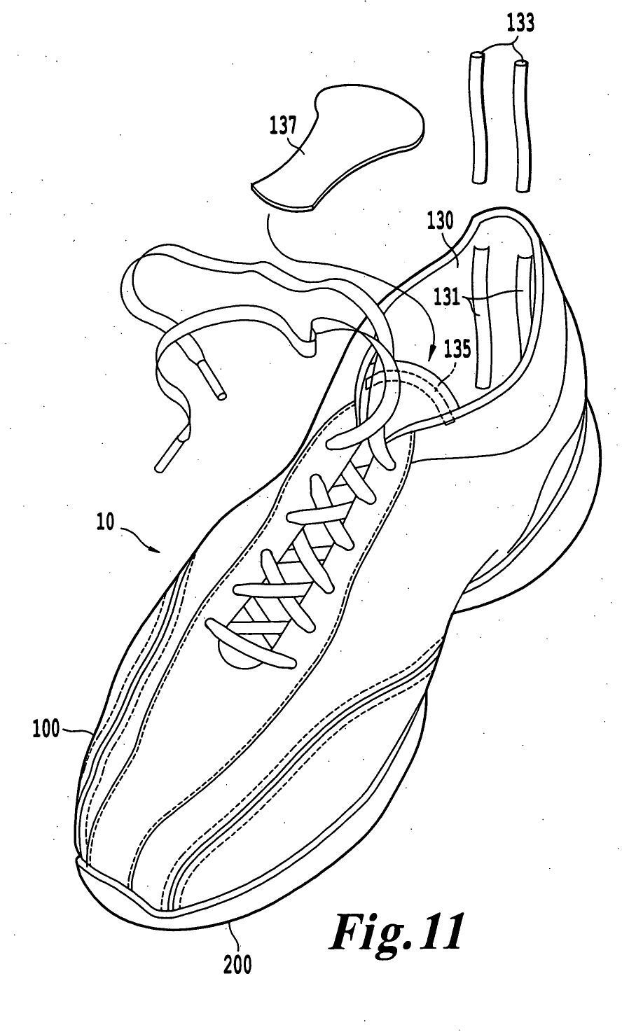

While the figures previously discussed present footwear components formed on an insole or sole assembly, footwear components can be provided on the upper portion 100 as well. According to one aspect of the invention, a pocket may be formed on a surface of the upper in order to receive an upper component configured to customize a fit of the upper to a characteristic of the wearer. FIG. 11 shows a show upper having footwear components in accordance with an embodiment of the present invention. As seen in this figure, an interior surface 130 of the upper 100 includes pockets 131 configured to receive heel guide components 133. The heel guide components 133 are preferable tubular shaped components that provide opposing raised bulges in the interior surface 130, which function to guide the wearer's heel into the shoe upper 100, and to act as a heel seat to tighten and accommodate for variations in heel anatomy, (narrow, normal and wide) heel widths. The tubular material (133) may be made of a material which has the ability to grasp socks and skin and further prevent slippage. The interior surface 130 may also include a pocket configured to receive a sizing component that adapts the interior surface to a characteristic of the wearer. For example, FIG. 11 shows a tongue pocket 135 provided on an underside of the shoe tongue to receive a tongue component 137 therein. The tongue component thickens the tongue to occupy more or less volume of the shoe cavity in accordance with the volume dimensions and/or preference of the wearer. Member 137 can have a variety of thicknesses and durometer hardnesses which assists the shoe's ability to apply retrograde pressure against the foot to ankle articulation and promote proximal positioning of the foot to heel counter 130. Interior surface pockets may also be used in the upper interior sidewalls or any other interior surface of the shoe upper.

In accordance with the present invention, each footwear component is associated with a characteristic of the wearer, and the footwear components are combined to provide a custom shoe for the wearer. As used herein, the term “custom shoe” means a shoe having at least two components that are independently associated with a characteristic of the wearer and combined to provide a custom shoe.

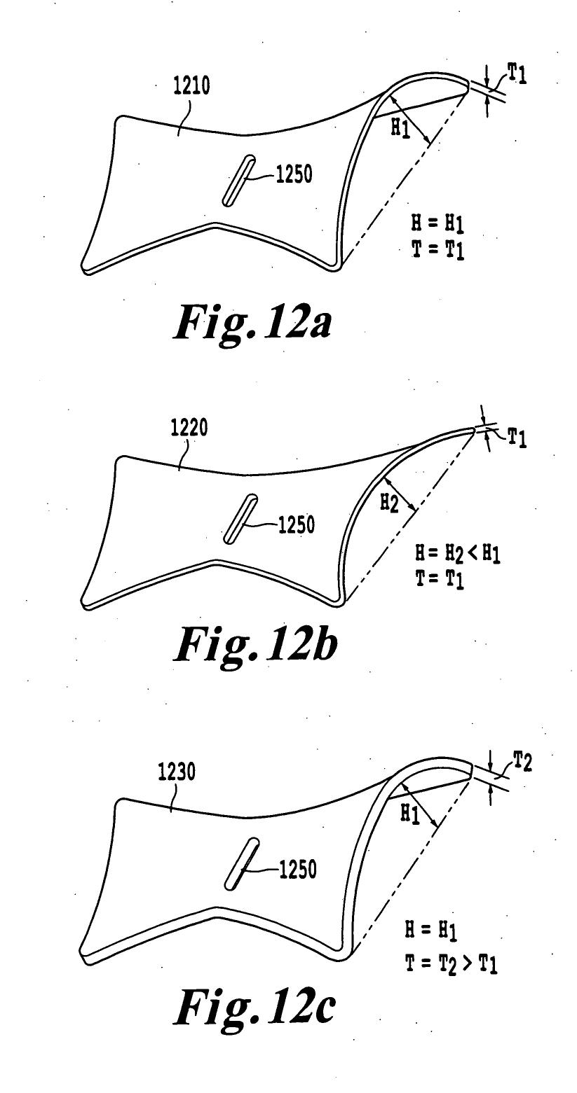

In one aspect of the present invention, at least one of the footwear components is selected from a plurality of pre-manufactured footwear components having substantially the same function, but having different physical attributes to accommodate different foot configurations. FIGS. 12a-12c show a plurality of pre-manufactured arch supports 1210, 1220 and 1230 that may be used to provide a custom shoe in accordance with the present invention. In one embodiment of the present invention, the arch supports 1210, 1220 and 1230 are made of plastic to provide a rigid structure that functions to support the longitudinal arch of a foot. As seen in the figures, each of the arch supports 1210, 1220 and 1230 include an aperture 1250 that is used to attach the arch support to an insole. Thus, the aperture 1250 allows the arch supports 1210, 1220 and 1230 to be interchangeable with one another on a particular insole. It is understood that the aperture 1250 is not necessary to provide interchangeability, and other mechanisms may be used, including simply providing a common mating surface among arches, which is configured to mate with a surface of the insole. In a preferred embodiment, each arch is capable of being used for a left or right insole. For example, the arch 1210 may accommodate a left insole when oriented as shown in FIG. 12a, but also can accommodate a right insole when oriented in a different direction. Other interchangeable footwear components may also be designed to accommodate a left or right insole.

Although the arch supports are interchangeable and provide substantially the same function, the arch supports 1210, 1220 and 1230 have different physical attributes that accommodate different characteristics of a foot. As seen in FIG. 12, for example, arch support 1210 has an arch height H1 while arch support 1220 has a height H2<H1. Thus, the arch supports 1210 and 1220 are designed to accommodate different longitudinal arches of a foot. However, the arch supports 1210 and 1220 each have a thickness T1, which provides substantially the same flexibility characteristics for these arches. As seen in FIG. 12c, the arch support 1230, includes an arch height H1 the same as the arch support 1210, but has a thickness T2>T1 thereby providing a less flexible arch support. Thus, arch support 1210 is designed to accommodate a foot requiring a more flexible support, such as that of an older individual.

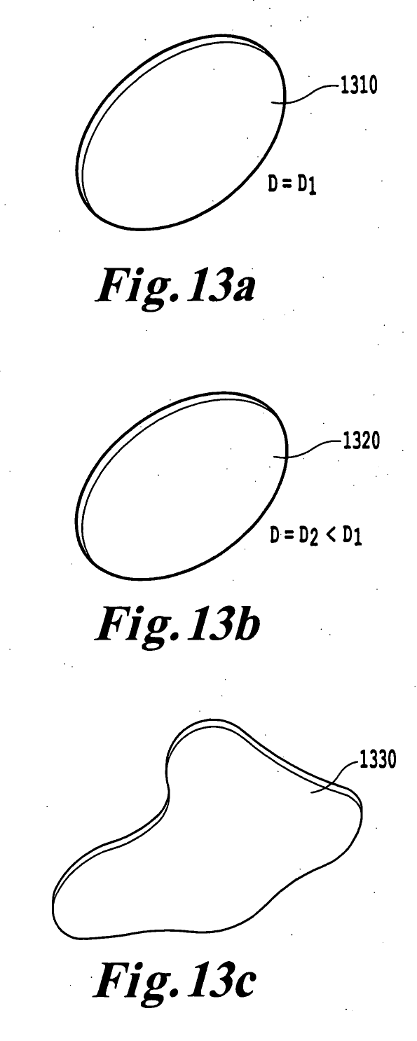

FIG. 13 shows a plurality of pre-manufactured heel pads 1310, 1320 and 1330 that may be used to provide a custom shoe in accordance with the present invention. In one embodiment of the present invention, the heel pads 1310, 1320 and 1330 are made of a gel-type plastic material to provide a cushion for the wearer's heel upon impact. As seen in the figures, each of the heel pads 1310, 1320 and 1330 include a mating surface 1350 that is used to attach the heel pad to an insole. Thus, the mating surface allows the heel pads 1310, 1320 and 1330 to be interchangeable with one another on a particular insole.

Although the heel pads are interchangeable and provide substantially the same function, the heel pads 1310, 1320 and 1330 have different physical attributes that accommodate different characteristics of a foot. Specifically, heel pad 1310 has a durometer hardness D1 while heel pad 1320 has a durometer hardness D2<D1. Thus, the heel pad 1320 provides a softer surface that may be designed to cushion a heel having a heel spur. While the heel pads 1310 and 1320 each have a same shape, heel pad 1330 has a different shape which may accommodate different pressure point characteristics of a foot.

FIGS. 12 and 13 provide only two examples of a footwear component that can be provided as a plurality of pre-manufactured components having substantially the same function, but different physical attributes to accommodate different characteristics of a wearer. It is to be understood that any of the footwear components discussed herein, or other footwear components, can be provided as a plurality of pre-manufactured components as discussed above. For example, a footwear component may be the insole of FIG. 8, where a plurality of insoles each have different durometer hardness ratings among the various insole regions discussed in FIG. 8. In addition, any number of plurality of interchangeable pre-manufactured footwear components can be provided in accordance with the resent invention. Other examples of footwear components include a tendon padding. Still further a super absorbent polymer for moisture management, antimicrobial or scented microbeads may be used with any embodiment of the invention disclosed herein.

Moreover, FIGS. 12 and 13 provide only examples of physical attributes that can be varied in a footwear component to accommodate different wearer characteristics. It is to be understood that physical attributes such as size, shape, configuration, material composition, duometer hardness, material density or any other physical attribute may be varied among interchangeable footwear components to match different characteristics of a person. In a preferred embodiment of the invention, the variations among a footwear components provide incremental changes in the footwear component that cover the spectrum of foot types in a population. For example, the arch height among arch supports can be incrementally changed among a plurality of interchangeable arch supports in order to accommodate substantially any arch height that may be found in a foot. The variation among footwear components can be in very small increments resulting in a large number of interchangeable footwear components to choose from, or in larger increments to reduce the number of interchangeable footwear components to choose from. The size of the increment can depend on the functionality of the particular component, the degree of variation in foot types for a component, manufacturing and inventory considerations, or other factors.

As discussed in the Background section above, a main impediment to existing customized shoe products is that the customer must wait a long time to receive the custom product, and iterative reworks can be frustrating. The system of premanufactured interchangeable footwear components described above allows a customer to select and purchase a custom shoe in a retail setting in a relatively short time period. Specifically, with the present invention a customer can enter a retail store and select a shoe design as usual. Once the design is selected, a salesperson in the retail store can obtain detailed information relating to the customer's foot such as dimensions and pressure points of the foot, what sport the user is involved in etc. This data is then used by the salesperson to identify prefabricated shoe components that are well suited to the customer. The shoe components are combined into a shoe that is anatomically customized to the purchaser's foot and the customer then tries the shoe on as in the usual retail setting. Based on the customer's personal preference, the purchaser may wish to modify a particular feel of the shoe. Unlike the custom shoe solutions discussed the background, a shoe in accordance with the present invention may be re-customized in the retail setting in a short period of time. For example, if the customer indicates that the arch support is uncomfortable, then the salesperson can replace the initially selected arch support with a lower arch support that may be more acceptable to the wearer.

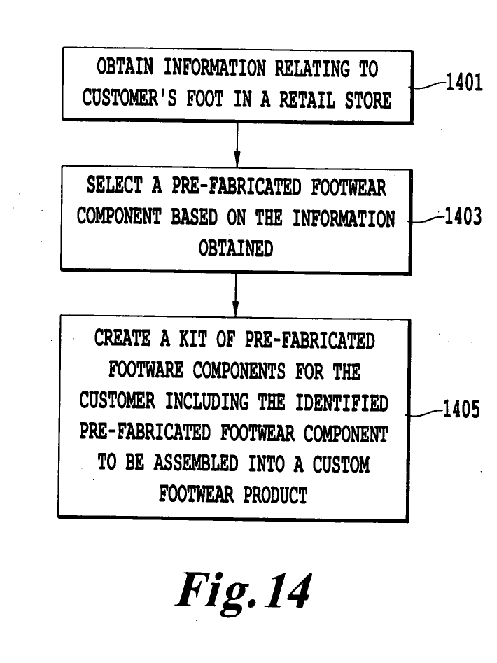

FIG. 14 is a flow chart of a process for providing customized footwear in accordance with an embodiment of the present invention. As seen in this figure, the process begins with step 1401 of obtaining information relating to a characteristic of the customer's foot in a retail store. The information obtained in step 1401 may include measured and/or non-measured information that relates to a characteristics of the customer's foot. Measured information may include two dimensional foot measurements, three dimensional foot measurements, pressure point measurements, weight measurements, gait length measurements or any other physical measurement of the customer that relates to a characteristic of the customer's foot. Non-measured information may include medical diagnoses relating to the customer's foot or biomechanical problems. Non-measured data may also include demographic information such as age and sex of the customer, as well as the customer's occupation, habits, activity level or any other non-measured information about the customer that relates to a characteristic of the customer's foot.

The information of step 1401 may be obtained manually or with the use of electronic and sensory equipment, or both manually and automatically. Manual retrieval of the information may include a trained retail store representative physically measuring length and width foot dimensions, and observing unique characteristics of the customer's foot such as a high arch. For example, step 1401 may consist of a retail store employee measuring the customer's foot with the aid of a mechanical measuring device such as the Brenning device familiar to most purchasers. The retail store representative may also manually gather information from the customer about his/her particular foot problems, his/her activity level etc., which aid in customizing a shoe for the customer. In a preferred embodiment of the invention, anatomical measurements of the customer's foot are automatically obtained by computer and sensory equipment, and non-measured data is automatically collected by a computer terminal based on customer input in response to a series of questions presented to the customer by the terminal. A system for automatically obtaining information relating to a characteristic of the customer's foot will be discussed below.

Once the information is collected in step 1401 a prefabricated footwear component is selected based on the information obtained, as shown by step 1403. As described in FIGS. 1-11 above, a shoe in accordance with the present invention can be assembled from several functional footwear components such as an arch support, a metatarsal pad, a heel clip, a tread segment etc. As further described in FIGS. 12 and 13 each footwear component can be selected from a plurality of prefabricated footwear components having substantially the same function, but having different physical attributes corresponding to a characteristic of the wearer. Selection may be performed manually by a retail store representative, or automatically. Where manual selection is used, associating the proper footwear component is a cognitive step performed by the store representative based on his or her knowledge and experience in relation to the information obtained for a particular customer. However, the store representative is preferably aided with charts, tables, or other tools for assisting in associating one of a plurality of interchangeable footwear components with a particular customer.

In one embodiment, the retail store may include a storage matrix for each footwear component that assists the representative in matching a component with the characteristics of the customer. Using an arch support as an example, the storage matrix may include a plurality of horizontal rows of storage compartments, each row corresponding to an arch height or range of arch heights for a customer. Stacking these rows of compartments upon one another creates a plurality of vertical columns that can each correspond to a particular use of the shoe such as running, tennis, walking etc. A compartment corresponding to a particular size range and a particular shoe use, will store an arch support that is suitable to a customer meeting these particular characteristics. Thus, once the store representative has identified customer characteristics, it is easy for the representative to identify the footwear component corresponding to the characteristics. It is to be understood that different storage matrices may be used for different footwear components. Moreover, while the above example provides only two characteristics for identifying a footwear component, more complex systems may be used to consider a larger number of factors. In a preferred embodiment, the footwear component is automatically selected by a computer system as will be described below.

Once the prefabricated footwear component is selected, a kit of footwear components that includes the identified footwear component is created in step 1405. As the footwear component which was associated with the particular customer in step 1403 is included in the kit of footwear components, the kit may be assembled into a shoe that is customized to the particular customer. Creation of the kit in step 1405 may include the sales representative manually creating a list of the footwear components prior to gathering and assembling the components into a custom shoe. Alternatively, creation of the kit may be done by a computer system, and may be embodied in a list of components printed by the computer for the representative. In one embodiment, the kit of parts includes a shoe shell selected based on the customer's foot size, an insole having an expansion member configured to adapt the shoe shell to the customer, and an arch support that is specifically associated with the user and attached to the insole prior to inserting into the shoe. Preferably, however, the kit of parts includes multiple footwear components that are each associated with a characteristic of the wearer to provide a high degree of customization. As previously noted, the plurality of functional components may be separable or integral to a part of the shoe such as the insole.

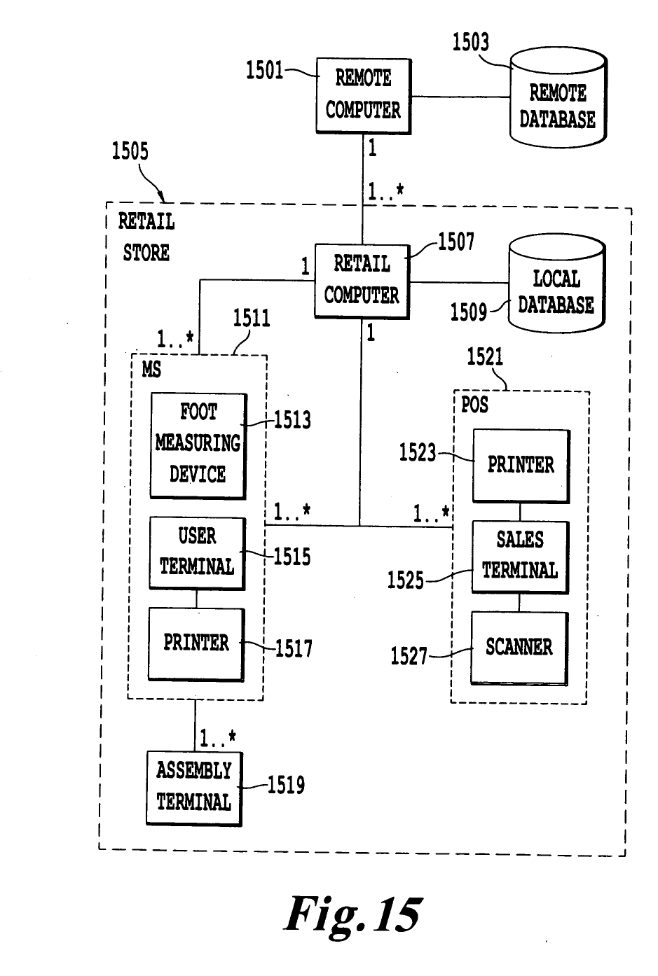

FIG. 15 is a computerized system for providing customized footwear to a consumer in accordance with an embodiment of the present invention. The system of FIG. 15 includes a retail store system including remote computer 1501, remote database 1503, one or more retail stores 1505, a retail computer 1507, a local database 1509, one or more measuring stations 1511, one or more assembly terminals 1519 and one or more point of sale stations 1521. As seen in FIG. 15, each measuring station 1511 includes a foot measuring device 1513, a user terminal 1515 and a printer 1517, and each point of sale terminal 1521 includes a printer 1523, a sales terminal 1525 and a scanner 1527.

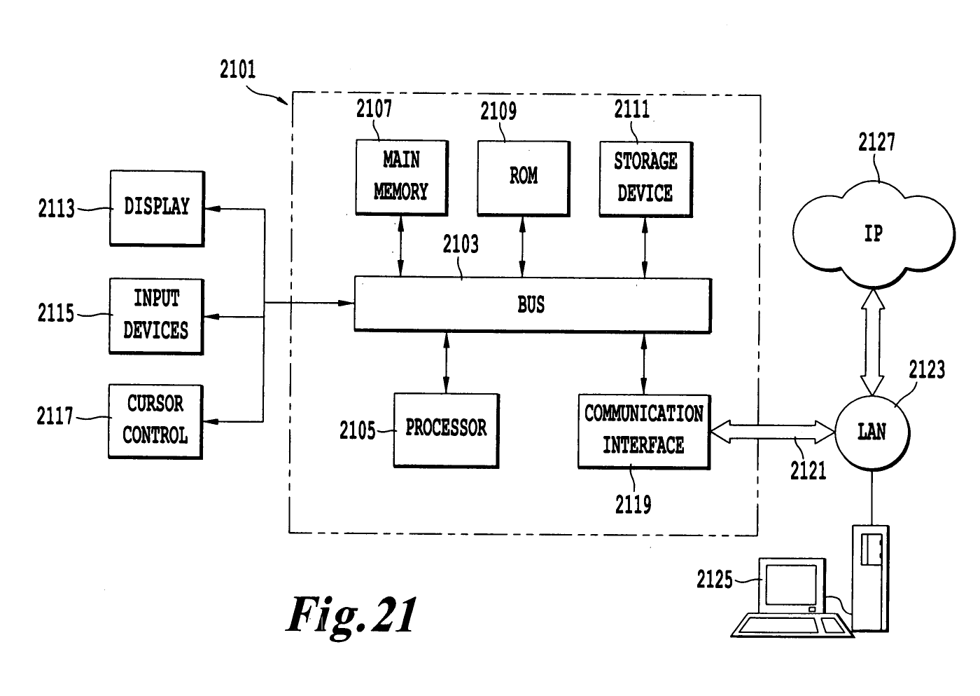

The remote computer 1501 is any suitable workstation, server, or other device for communicating with the retail computer 1507 and for storing information in and retrieving information from the remote database 1503. In one embodiment of the present invention, the remote computer 1501 serves as a backup system to the retail computer 1507 for selecting footwear components for a customer in the retail store 1505. The remote computer 1501 may also determine purchasing behavior of a particular customer and deliver such information to the retail store 1505 to assist in sales efforts. The remote computer 1501 communicates with the retail computer 1507 using any suitable protocol and may be implemented using the computer system 2101 of FIG. 21, for example.

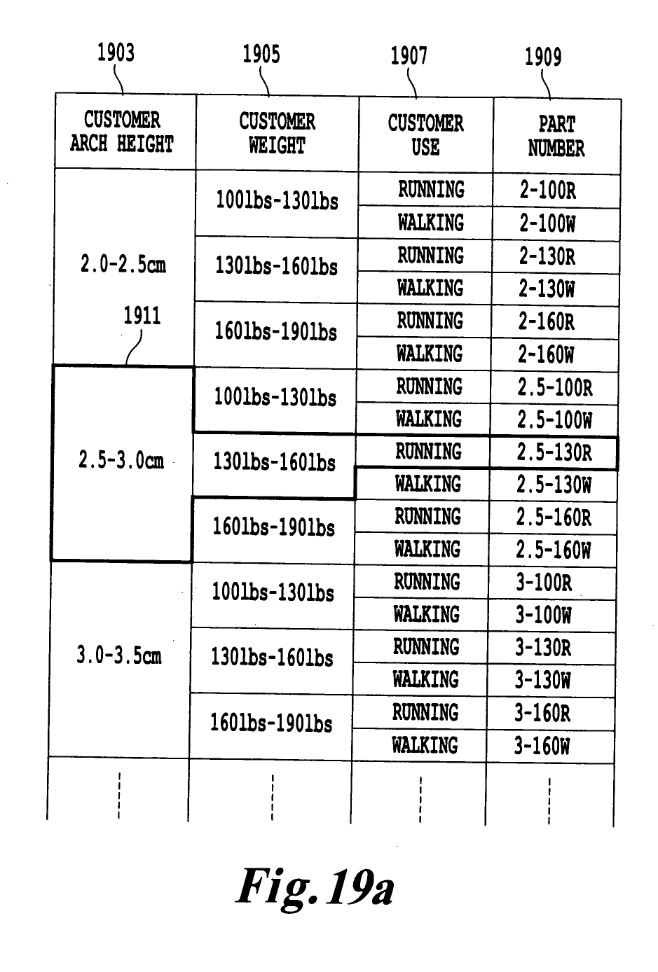

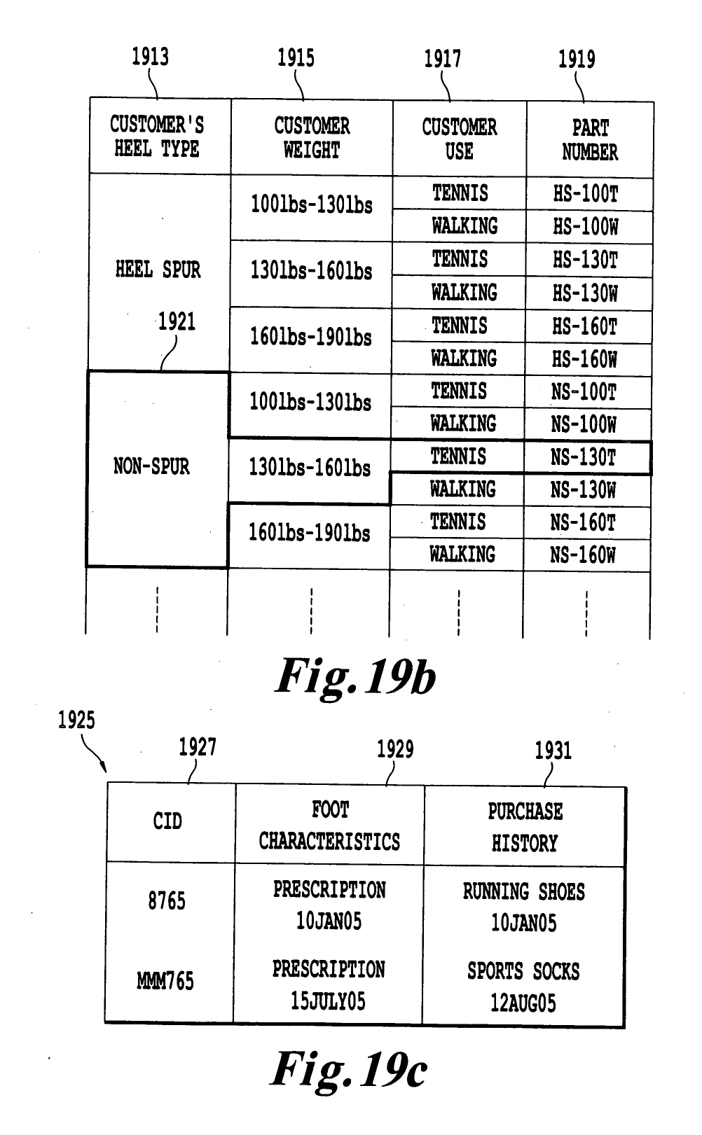

The remote database 1503 is a file that includes records containing information for associating footwear components with a particular customer in accordance with an embodiment of the present invention. This information includes measured and non-measured characteristics of the customer in relation to footwear components having particular physical attributes. Measured information may include two dimensional foot measurements, three dimensional foot measurements, pressure point measurements, weight measurements, gait length measurements or any other physical measurement of the customer that relates to a characteristic of the customer's foot. Non-measured information may include medical diagnoses, biomechanical problems, demographic information such as age and sex of the customer, as well as the customer's occupation, habits, activity level or any other non-measured information about the customer that relates to a characteristic of the customer's foot. Footwear selection tables that may be stored in the remote database 1503 will be discussed with respect to FIGS. 19a and 19b below.

The remote database 1503 may also include records containing information for associating a particular customer identification to a foot profile unique to the customer, and/or to a purchase history unique to a customer. The remote database can be used to store various data relating to a customer. Customer information tables that may be stored in the remote database 1503 will be discussed with respect to FIG. 19c below. Records in the remote database 1503 contain fields together with a set of operations for searching, sorting, recombining, and other database functions. The remote database 1503 may be implemented as two or more databases, if desired.

The retail store 1505 is generically referred to as a retail location and is a place where goods are kept for retail sale to customers. As noted above, many retail stores 1505 may be connected to the remote computer 1501. This allows a plurality of stores to access information unique to a customer, should the customer shop in different retail stores.

The retail computer 1507 may be implemented using the computer system 2101 of FIG. 21, for example, or any other suitable PC, work station, server, or device for communicating with the remote computer 1501, for storing and retrieving information in the local database 1509, for monitoring data transmitted between the measuring station 1511, assembly station 1519 and point of sale 1521. In one embodiment, the retail computer 1507 can control the foot measuring device 1513, display 1515 and printer 1517 of the measuring station 1511, as well as control the printer 1523, terminal 1525 and scanner 1527 of the point of sale 1521. According to one embodiment, the retail computer 1507 associates footwear components with a particular customer based on a characteristic of the customer in accordance with an embodiment of the present invention.

The local database 1509 is a file that includes records containing information for associating footwear components with a particular customer in accordance with the present invention. The records in the local purchase database 1509 contain fields for associating footwear components with a particular customer. The local database 1509 also includes operations for searching, sorting, recombining, and other database functions. The local purchase database 1509 may be implemented as two or more databases, if desired. Periodically, (e.g., daily) foot profiles and sales transaction information stored in the local database 1509 are retrieved by the retail computer 1507 and sent to the remote computer 1501, which uses the information to update customer profiles stored in the remote database 1503.

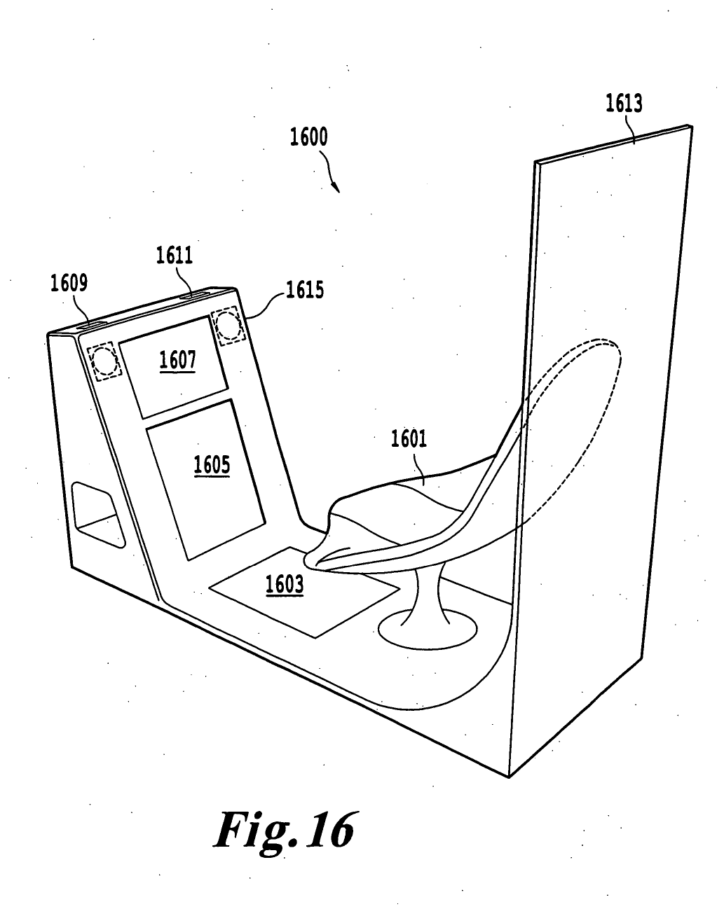

The retail store 1505 includes one or more measuring stations 1511 that interface with a footwear customer. The measuring stations include a foot measuring device 1513 having scanning and/or other sensory tools configured to obtain information representative of the customer's foot in accordance with an embodiment of the present invention. In the embodiment of FIG. 15, the measuring station 1511 also includes a user terminal 1515 for the footwear customer and/or retail representative to input information and view a display of information from the measuring station. The measuring station 1511 also can include a printer to print information such as a kit of footwear components that will be combined into a custom shoe. Examples of measuring stations will be discussed further with respect to FIGS. 16-18 below.

The retail store 1505 also includes one or more assembly stations 1519. The assembly station 1519 is any computer or device for communicating with the measuring station 1511 and/or retail computer 1507 to assist a retail representative in assembling a custom shoe. In one embodiment of the present invention, a prescription of the customer's foot is sent directly to the assembly station to inform a retail representative of the footwear components necessary to provide a custom shoe for the customer.

J The retail store 1505 also includes one or more points of sale 1521. Each point of sale 1521 preferably includes a corresponding printer 1523, a terminal 1525 and a scanner 1527. The terminal 1525 communicates with the retail computer 1507 and the scanner 1527. The scanner 1527 may be implemented as any conventional scanning device for reading footwear product information such as an item code from bar codes or other indicia on the footwear product. This information read by the scanner 1527 is transmitted to the retail computer 1507 via the terminal 1525. The retail computer 1507 uses the scanned information and the information stored in the local database 1509 and/or remote database 1503 to determine information of the transaction including product price, quantity, and product description, for example. Purchase receipts may be printed on the printer 1523 in response to receiving commands from the retail computer 1507 and/or sales terminal 1525.

It is to be understood that the system in FIG. 15 is for exemplary purposes only, as many variations of the specific hardware and software used to implement the present invention will be readily apparent to one having ordinary skill in the art. For example, the functionality of the retail computer 1507 and the assembly terminal 1519 may be combined in a single device. To implement these variations as well as other variations, a single computer (e.g., the computer system 2101 of FIG. 21) may be programmed to perform the special purpose functions of two or more of any of the devices numbered 1501 through 1527 shown in FIG. 15. On the other hand, two or more programmed computers may be substituted for any one of the devices numbered 1501 through 1527 shown in FIG. 15. Principles and advantages of distributed processing, such as redundancy and replication, may also be implemented as desired to increase the robustness and performance of the system, for example.

FIG. 16 shows a measuring station that may be used in accordance with an embodiment of the present invention. The measuring station 1600 includes a customer seat 1601, foot measuring devices 1603 and 1605, display 1607, printer output 1609, card reader 1611, speakers 1615 and back board 1613. As seen in FIG. 16, the seat 1601 is situated to allow a seated customer to place his or her feet on the foot measuring devices 1603 and 1605, while the customer can also view the display 1607 and access the printer output 1609 and card reader 1611. In the embodiment of FIG. 16, the foot measuring devices 1603 and 1605 provide measurements of static non-weight bearing characteristics of a customer's foot. Thus, the in the embodiment of FIG. 16, the customer's feet are simply placed in a relaxed state on either measurement device 1603 or 1605 while the customer is seated in the chair 1601. The measurement devices 1603 and 1605 may be designed to provide the same or different measurement characteristics. Moreover, although the devices 1603 and 1605 can obtain measurements of a foot having a sock thereon, the customer's socks are preferably removed to improve accuracy of measurement.

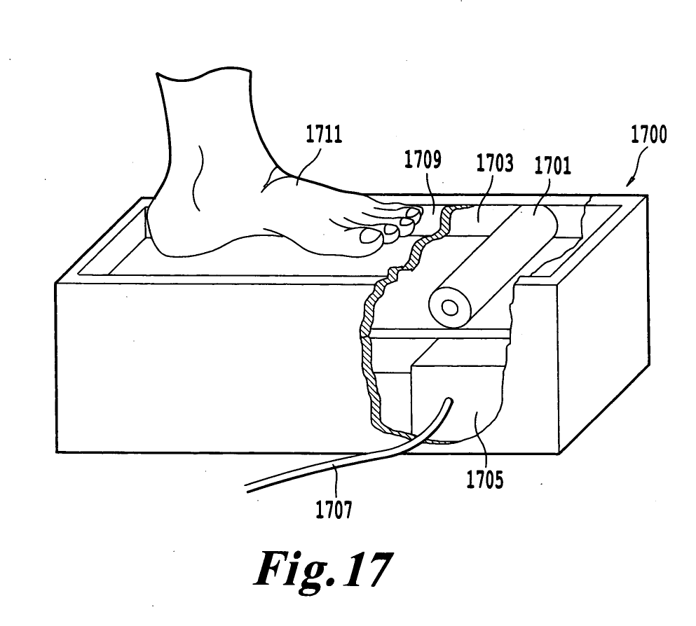

FIG. 17 is an optical foot scanning device that may be used as the foot measuring device 1600 in accordance with an embodiment of the present invention. The electro-optical foot scanner 1700 includes an optical scan head 1701 which moves along a fixed track 1703 during the scan process. Scanner 1700 also includes a control unit 1705 which adjusts the light intensity of the optical scan head 1701, the speed at which the optical scan head 1701 moves within track 1703 during scanning operations, and the flow of data to and from a central computer such as retail computer 1507 which can be coupled to the scanner 1700 through logical connection 1707. Scanner 1700 also includes a planar reference surface 1709. Other shaped reference surfaces may be substituted for planar reference surface 1709 without departing from the teachings of the present invention. For instance, a reference surface generally formed such that it conforms to the bottom surface of a foot may be utilized.

During a typical scanning operation a foot to be scanned 1711 is placed on one side of reference surface 1709 such that the bottom facing surfaces of the foot 1711 are proximate the reference surface 1709. Optical scan head 1701 moves along track 1703 along the other side of reference surface 1709. In a preferred embodiment the control unit 1705 provides a reference surface which is large enough to accommodate foot sizes up to twenty according to the Brannock measuring system. Scanner 1700 may provide 520×220 pixel resolution where each pixel is 5 mm square, however other resolutions may be used. In addition, the scanner 1700 preferably allows adjustment of the light source intensity used in conjunction with the optical scan head including eight levels of brightness and six levels of contrast. The scanner preferably provides a relatively quick optical scan head movement and therefore relatively quick scanning of the bottom facing surface of foot 1711.

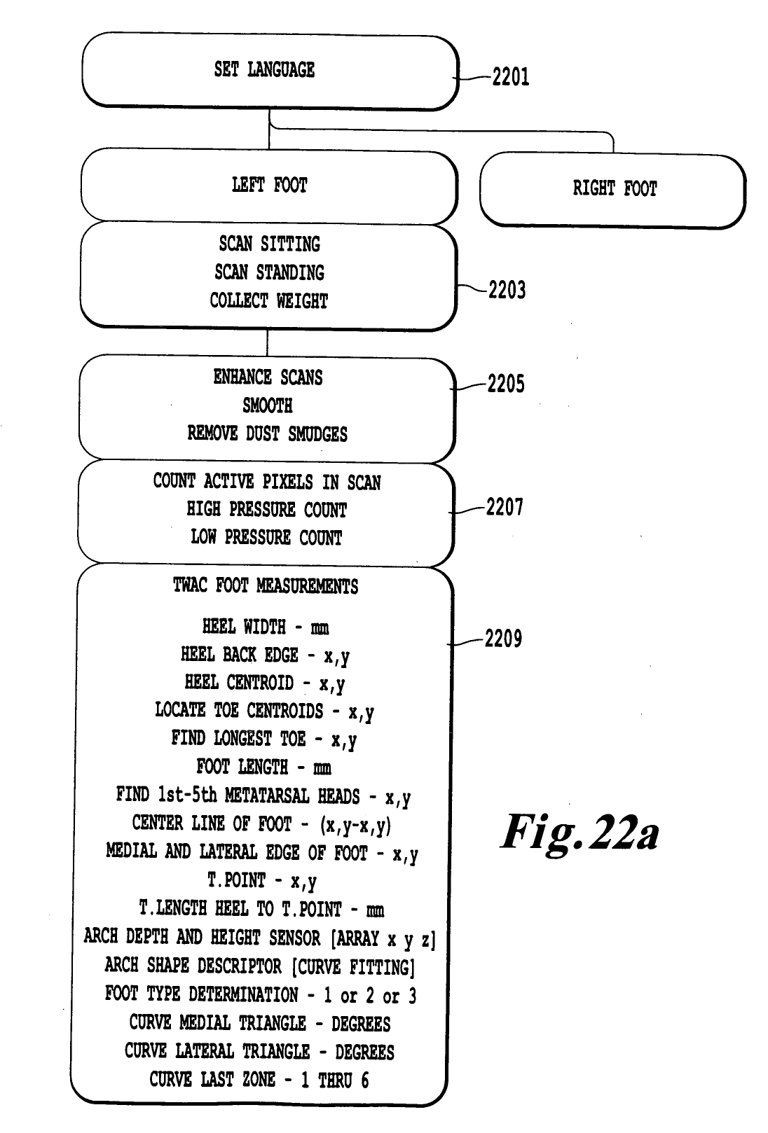

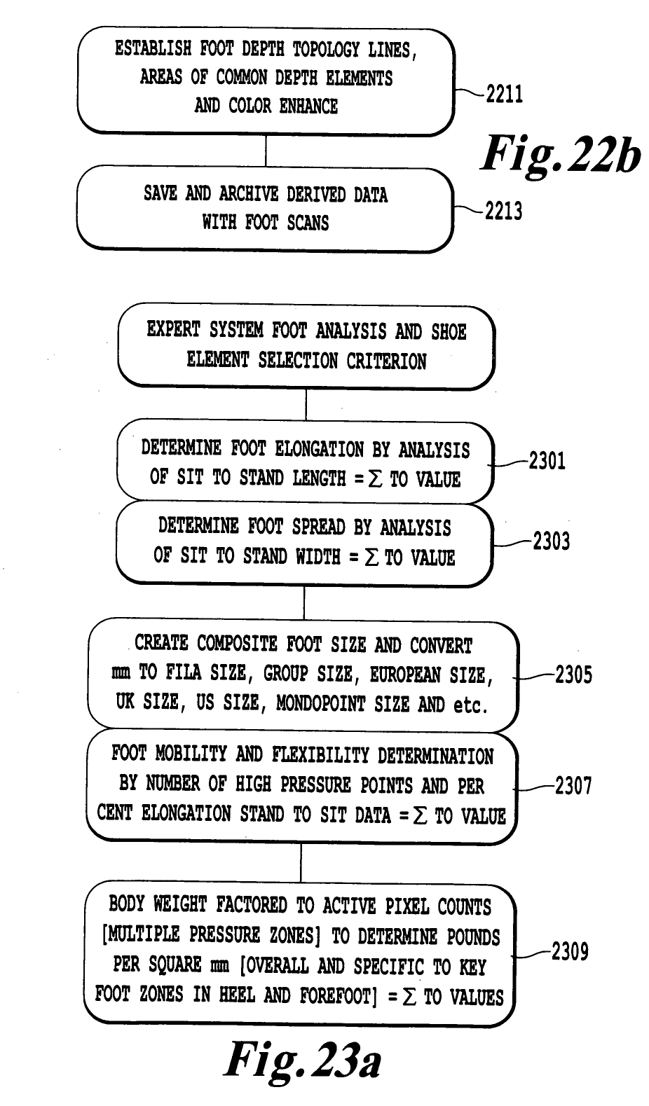

According to one embodiment, the retail computer 1507 includes computational elements for deriving a level heel to foot length, foot width, arch-line, and foot curvature measurement from the data received from foot image data received from scanner 1700. Methods for deriving foot measurement data from an optical scanning device are disclosed in U.S. Pat. No. 5,195,030, U.S. Pat. No. 5,123,169, U.S. Pat. No. 5,128,880, U.S. Pat. Nos. 5,206,804 and 5,216,594, the entire contents of each of which is incorporated herein by reference. In one embodiment, the scanner can be equipped with a sensor or detector for measuring the customer's weight. This embodiment will be described further with respect to FIG. 22 below.

Returning to FIG. 16, display panel 1607 displays information to the customer about characteristics of the customer's foot. In accordance with one embodiment of the present invention, the display 1607 is a touch screen panel that allows the customer to input information. For example, messages displayed on the display 1607 and/or provided orally by the speakers 1615 may prompt the customer to input non-measurement information such as age, shoe use, personal comfort preferences etc. Moreover, the display 1607 and speakers 1615 can provide the customer with a multimedia presentation about unique characteristics of the user's foot, and shoe configurations that are appropriate for the user.

Foot measuring station 1600 may also include a card reader 1609 that accepts a personal identification (ID) card unique to the customer. The customer ID card may be a credit card, debit card, license, a unique footwear card, a shopper loyalty card or any other card that provides a unique ID for the customer. While not shown in FIG. 16, the backboard 1613 may include a brand logo as well as display shelves for shoe designs.

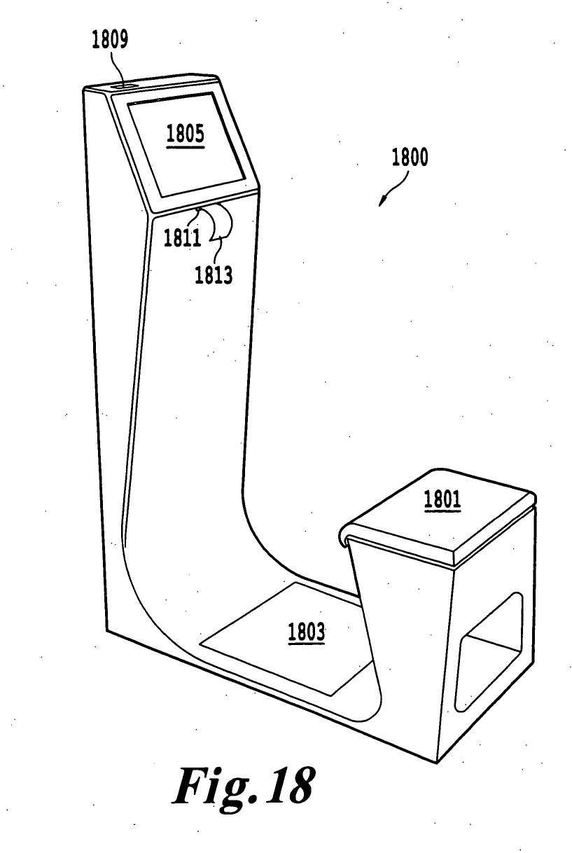

FIG. 18 shows a measuring station 1800 that may be used in accordance with an embodiment of the present invention. As seen in this figure, the station 1800 includes a seat 1801, foot measuring device 1803, a display 1805, a card reader 1809 and a printer slot 1811 for outputting printed paper 1813. The measuring station of FIG. 18 is designed to provide both static and dynamic measurements of the customer's foot. Specifically, the seat 1801 is situated such that a customer may place their feet on the foot measuring device 1803 in a relaxed non-load bearing state. Static weight-bearing measurements may then be taken as the customer stands on the measuring device 1803. Finally, dynamic measurements may be taken by the customer placing his or her left foot on the device while stepping through the station 1800 in one direction, and then placing a right foot on the device 1803 while stepping through the station in an opposite direction.

The measuring device 1803 is preferably a foam mat equipped with a plurality of electrostatic and pressure sensors. With such a mat, the foam conforms to the contours of the customer's plantar region to provide actual three dimensional measurements of the customer's foot. Using such a foam mat, motion, velocity, mass and 3d surfacing can be evaluated for the customer to select a particular footwear component in accordance with an embodiment of the present invention. Further weight, body sway, limb length discrepancy, gait cycle events, static 2d and 3D imaging, dynamic 2D and 3D imaging, pronation and supination events and body mass migration measurements can be taken.

As with the measuring station of FIG. 16, the display panel 1805 displays information to the customer about characteristics of the customer's foot, and can include a touch screen panel that allows the customer to input information. Further 1809 can accept a personal identification (ID) card unique to the customer. While not shown in FIG. 18, a back portion of the display stand may include a brand logo as well as display shelves for shoe designs.

It is to be understood that the measuring stations 1600 and 1800, as well as the foot measuring devices described as relating thereto are exemplary only, and other foot measuring configurations may be used. For example, foot measurements may be taken by a portable carpet manufactured by GaitRite. The portable carpet provides a 14 foot run of walking surface having more than 16,000 sensors that capture electronic footprints of a customer in full gait to measure cadence, step length, velocity and other gait parameters. In one embodiment, the sensory carpet may be implemented in a treadmill configuration.

The present invention stores information relating to footwear components as well as customer information, for example. This information is stored in one or more memories such as a hard disk, optical disk, magneto-optical disk, and/or RAM, for example. One or more databases, such as the remote database 1503 and the local database 1509, may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 21, for example.

FIGS. 19a, 19b and 19c depict data structures used for implementing a system for providing a custom shoe in accordance with an embodiment of the present invention. The data structures are depicted in a relational format, using tables, whereby information stored in one column (i.e., field) of a table is mapped or linked to information stored in the same row (i.e., record) across the other column(s) of the table. These data structures are used by the remote computer 1501 and/or the retail computer 1507 to select footwear components for providing custom shoes in accordance with an embodiment of the present invention. According to one embodiment, the data structures shown in FIGS. 19a and 19b are stored in the local database 1509 and the remote database 1503, while the data structure shown in FIG. 19c is stored only in the remote database 1503 However, it is to be understood that any other suitable storage device(s) or medium(s) may be used.

FIG. 19a is an arch support selection table that is used to match various customer characteristics to a pre-manufactured arch support in accordance with an embodiment of the present invention. The arch support selection table 1901 is preferably stored in the local database 1509, but may be stored in the remote database 1503 so that the remote computer 1501 can serve as a backup system for identifying arch supports for a custom shoe. As seen in FIG. 19, the table 1901 includes a customer arch height field 1901, a customer weight field 1905, a customer use field 1907 and an arch number field 1909. Each entry of the arch height field 1903 includes a range of arch heights. For example, the first entry in column 1903 includes an entry “2.0-2.5 cm,” the second entry includes “2.5-3.0 cm” and the third entry includes “3.0-3.5 cm.” Thus, in table 1901, the customer arch height entries are successive ranges of arch heights that cover a continuous spectrum of arch heights that may be measured for a customer's foot. As shown by the ellipses in column 1903, the arch height column can include more range values.

The customer weight field 1905 also includes successive ranges of weights that may be measured from a customer. For example, FIG. 19a includes the ranges “100-130 lbs,” “130-160 lbs,” and “160-190 lbs.” The customer use column 1907 includes running and walking as examples of a customer's primary use of the shoe. The ellipses in FIG. 19a indicate that more entries may be included in each column. As seen in FIG. 19a, the customer weight ranges are repeated for each customer arch height, and the customer uses are repeated for each customer weight range. This configuration of the table 1901 allows various customer characteristics to contribute to the selection of a pre-manufactured arch listed in the arch number column 1909. The arch numbers in column 1909 each correspond to an arch having a unique physical attributes suitable for a foot that meets the combination of characteristics correlated to the arch number in the table 1901.

For example, foot measuring station 1800 may measure a particular customer's arch height at 2.7 cm, and the customer's body weight at 148 lbs, as described above. Moreover, as these measurements are taken, the measurement station 1800 may have obtained information from the customer indicating that the primary use for the shoe will be walking. With this information, the retail computer 1507 searches the arch support selection table 1901 and finds that these characteristics are included in a unique record 1911 that identifies arch support numbered 2.5-130R. Thus, the retail computer 1507 can select this arch support for use in a custom shoe to be assembled for the customer. This selection may be output by the measuring station 1800 by printing, display and/or orally, so that the arch support can be physically obtained and included in a custom shoe.

FIG. 19b is a heel pad selection table that is used to match various customer characteristics to a pre-manufactured heel pad in accordance with an embodiment of the present invention. The heel pad selection table 1913 is preferably stored in the local database 1509, but may be stored in the remote database 1503 so that the remote computer 1501 can serve as a backup system for identifying arch supports for a custom shoe. As seen in FIG. 19b, the table 1901 includes a customer heel type field 1915, a customer weight field 1917, a customer use field 1919 and a heel pad number field 1921. Thus, the heel pad selection table 1913 can include the same and/or different characteristics used in other footwear component selection charts such as the arch support selection chart.

As seen in FIG. 19b, the successive customer weight ranges are repeated for each customer heel type, and the customer uses are repeated for each customer weight range to allow various customer characteristics to contribute to the selection of a pre-manufactured heel pad listed in the heel pad number column 1921. The heel pad numbers in column 1921 each correspond to a heel pad having unique physical attributes suitable for a foot that meets the combination of characteristics correlated to the heel pad number in the table 1913. Thus, as seen in FIG. 19b, the record 1923 identifies heel pad number NS-130T as suitable for a customer that does not have a heel spur, weighs between 130-160 lbs and uses his shoe primarily for tennis. Thus, the retail computer 1507 can select this arch support for use in a custom shoe to be assembled for the customer. This selection may be output by the measuring station 1800 by printing, display and/or orally, so that the arch support can be physically obtained and included in a custom shoe.

In one embodiment of the present invention, a customer may have a Customer ID card that stores a unique ID of the customer in relation to the customer's foot characteristics, as well as in relation to purchase history information for the customer. FIG. 19c is a customer information table 1925 that includes a field 1927 for storing Customer IDs (CIDs), a field 1929 for storing a customer footwear characteristics in association with the CID, and a field 1931 for storing a purchase history in association with a CID. The customer information table 1925 stores CIDs of many different customers and information associated with each CID. Thus, as seen in the exemplary entries of FIG. 19c, the first entry in table 1925 associates information with the customer having the CID 8765, while the second entry of table 1925 associates information with a different customer having CID MMM765.

A CID is any identifier that is scanned, read, or otherwise entered into a computer system at a foot measuring station or POS terminal to identify a customer. Each customer may have multiple CIDs and each retail store may use any one of the CIDs to identify foot characteristics of the customer and/or track purchases of the customer. Thus, different retail stores may have a different CID for a particular customer. Examples of possible CIDs are credit card numbers, debit card numbers, social security card numbers, driver's license numbers, checking account numbers, street addresses, names, e-mail addresses, telephone numbers, frequent customer card numbers, shopper card identifications (SCIDs), or shopper loyalty card numbers issued by the retail store 1505, although any other suitable form of identification may be used.

The foot characteristics in column 1929 are preferably stored as a footwear prescription which may include a 3D image of anatomical measurements of the customer's foot, as well as non-measurement data as discussed above. By storing the customer's footwear characteristics, a customer can purchase custom shoes without the need to scan his or her foot before each purchase. Indeed, once the customer's foot characteristics are captured and shared, a customer can shop for custom shoes on-lone without entering a retail store. However, the on-line shopping will not allow the customer to have anatomically customized shoes to be modified to suit personal preferences of the customer. Further, it is preferably that the customer periodically update his or her footwear characteristics, as they may change over time. Thus, in the embodiment of FIG. 19c, the footwear prescription is also saved in relation to a date that the prescription was created.

The purchase histories stored in column 1931 provide a list of products and/or services previously purchased by a customer associated with the CID. In one embodiment, and referring to FIG. 15, the remote computer 1501 can poll the retail computer 1507 in each of the retail stores 1505 for purchase history information to update the purchase history information stored in the remote database 1503. The host computer 1501 preferably generates behavioral information from the purchase history information stored in the remote database 1503. This behavioral information may be any information that a market researcher (i.e., surveyor) wishes to use to determine whether a customer is likely to purchase a particular product. Examples of behavioral information are whether a customer has purchased tennis shoes in the past year, whether the customer has purchased sports socks in the last six months, and whether the customer consistently purchases running shoes.

While the above description is given with respect to a relational database for categorizing or associating footwear components for measured and non-measured characteristics, the present invention is not limited to this embodiment. For example, the selection of footwear components may be accomplished with an expert system process such as that described in FIGS. 22-24 below.

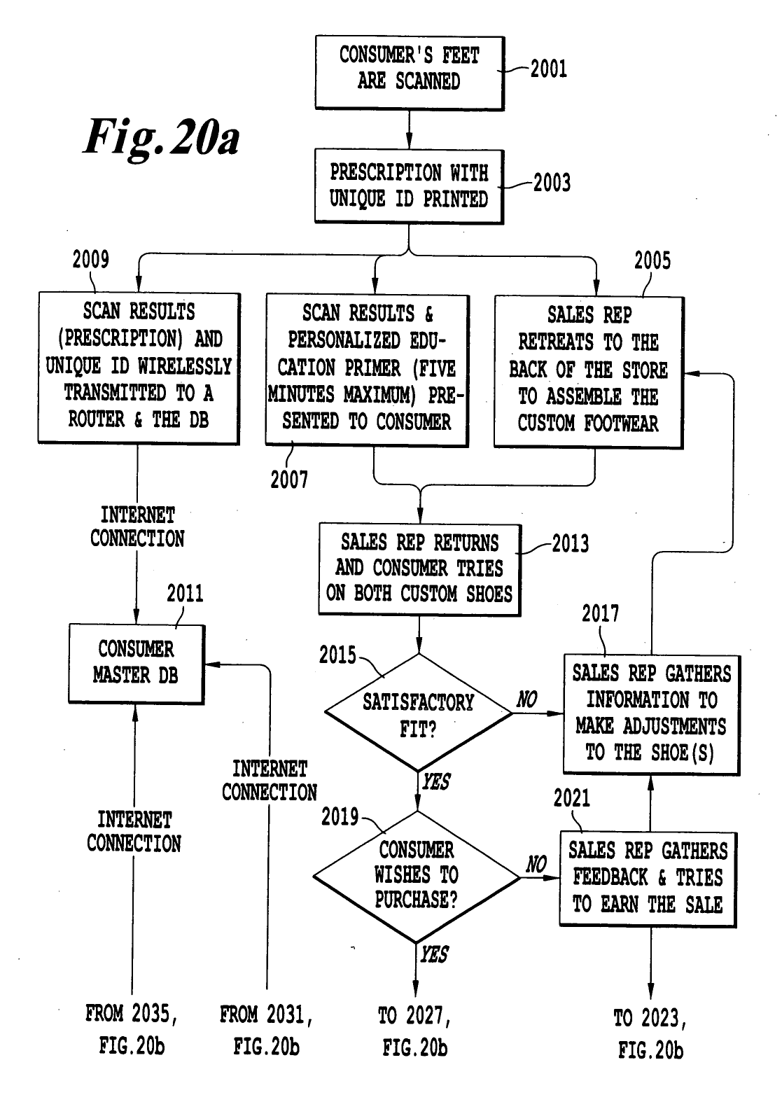

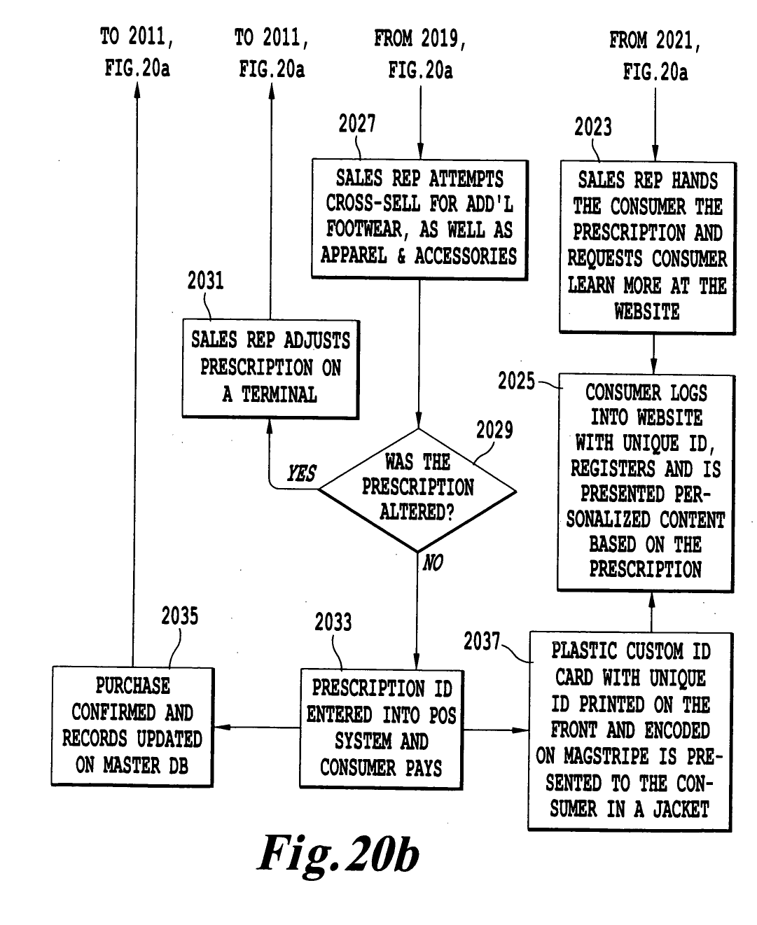

FIG. 20 is a flowchart explaining an in-store process for providing custom shoes in accordance with an embodiment of the present invention. The process begins when a customer walks into a retail store, such as the store 1505 of FIG. 15, to purchase footwear products and seeks the assistance of a sales representative. Thus, the process of FIG. 20 will be described with reference to the components of FIG. 15. According to the process of FIG. 20, the sales representative will direct the customer to a foot measuring station 1511 where the customer's feet are scanned as shown by step 2001 of FIG. 20. Thus, the scanning step 2001 obtains anatomical foot measurements and may also obtain other non-measured characteristics of the customer by way of user terminal 1515. Further, the scanning step 2001 prompts the retail computer 1507 to access footwear component selection charts from the local database 1509, and select footwear components that correspond to the characteristics obtained for the customer. In the process of FIG. 15, these selected footwear components are provided in a prescription with the customer's ID, which is printed on printer 1517, as shown by step 2003.

Once the prescription is printed, the sales representative retreats to the back of the retail store to assemble a custom footwear product in accordance with the printed prescription as shown by step 2005. At this time, the display 1515 provides scan results and a personalized education primer to the customer as shown by step 2007. Step 2007 is preferably a multimedia presentation that captures the customer's attention while the sales representative is assembling the customer's shoe in the backroom. In a preferred embodiment, assembly of the custom shoe will take no more than 5 minutes. In addition to printing the prescription and ID, the retail computer 1507 sends this information to remote database 1503 as shown by step 2009. In the embodiment of FIG. 20, the prescription and ID are wirelessly transmitted via a router and the Internet to the remote database, which is referred to as a “master database” in FIG. 20. However, hard wired transmission to a local or remote database may be used. The prescription is provided in a customer information table such as that described with respect to FIG. 19c above.

According to the process of FIG. 20, the presentation to the customer ends and the sales representative returns with the assembled shoes, at which time the customer tries on the custom shoes as shown in step 2013. The process then proceeds to step 2015 where the customer decides whether the shoes are a satisfactory fit. If the shoes are not satisfactory to the customer, the sales representative gathers information from the customer to make adjustments to the shoes, as shown by step 2017. The sales representative then returns to the back room in step 2005 to select alternative footwear components that meet the customer's required adjustments, and the customer tries the adjusted shoes.

Once the customer determines that the shoes fit, a decision is made as to whether the customer will purchase the shoes in step 2019. If the customer does not wish to purchase the shoes, the sales representative will gather feedback from the customer in an attempt to earn the sale as shown by step 2021. While not shown in FIG. 20, the representative may be aided in earning the sale in step 2021 by behavioral information obtained from the remote computer 1501 as previously discussed. If the customer still refuses to purchase the custom shoes, the sales representative gives the customer the printed prescription with the unique ID and directs the customer to a website as shown by step 2023. In one embodiment, step 2023 includes the sales representative uploading the customer's prescription and customer to the remote database 1503. The customer may then access the web site with the unique ID, and register to receive personalized information based on the customer's prescription as shown in step 2025. As the remote database has the prescription, the customer may purchase a custom shoe on-line without returning to the retail store. In one embodiment, the website is maintained on the remote computer 1501, however the retail computer may be used.

In one embodiment of the present invention, the consumer may be referred to an orthotics specialist for a specialized orthotic having a very high degree of customization to the consumer. This referral may be automatically provided as part of the prescription process in step 2003, or as part of the salesman trying to fit the consumer in steps 2015-2021. In a preferred embodiment, a retailer or footwearer company is affiliated with pre-selected orthotics specialist for referral. In return for the referral business, the orthotics specialists preferably agrees to provide orthotics specially adapted to the retailer or footwearer company shoes, and/or to purchase such shoes. Of course, other terms may be negotiated to compensate the retailer or footwearer company for the referral business.

Once referred to the orthotics specialist, the specialist measures the consumer's foot and creates a specialized orthotic based on the measurements. The measurement may be made using any known measurement method such as casting or manual methods, or by automated scanning such as that previously described herein. Automated scanning is preferable in order to avoid long lead times before the customer can receive the orthotic. Further, the specialized orthotic is preferably selected from pre-manufactured orthotics that require little or no modification in order to match the consumer's prescription. For example, pre-manufactured orthotics may be provided in a set of several dozen, or more, orthotics that have incremental differences across a broad range of foot types. One such pre-manufactured orthotic can be selected and fine tuned using manual modification techniques in order to meet the requirements for the footwear prescription in a short period of time. However, no matter what method is used to create the specialized orthotic, the specialized orthotic preferably meets the requirements of a medical grade orthotic, the cost of which is reimbursed by medical insurance such as Medicaid.

Where the purchaser decides to purchase the custom shoes at the retail store in step 2019, the process proceeds to step 2027, where the sales representative attempts to cross sell for additional footwear and apparel accessories. Where purchase history for the customer has been previously stored in the remote database, the sales representative can use behavioral information to determine possible products to suggest to the customer. Further, the remote computer 1501 may provide the sales representative with a coupon targeted to the customer to induce the customer to make a purchase. Systems and methods for providing promotions and/or coupons targeted to a customer are well known in the art.

In addition to cross sale efforts, the sales representative takes appropriate action to update the prescription if necessary as shown by step 2029. Specifically, if the prescription was altered by the sales representative based on feedback from the customer, then the sales representative manually adjusts the prescription corresponding to the customer's ID as shown by step 2031. Such manual adjustment is done on a terminal of the retail computer 1507, which accesses the remote computer 1501 to update the customer information table stored in the remote database 1503 as shown in step 2011. Where the prescription was not altered during the sale, the “no” path is followed from decision block 2029, and the prescription ID is entered into the point of sale system 1521 and the consumer pays for the custom shoes and any cross sale items as shown by step 2033.

Once the sale is completed, the retail computer 1507 confirms the purchase and updates the customer's purchase history on the remote database as shown by step 2035. This is done by the retail computer 1507 sending the recent purchase information to the remote computer 1501 by way of the Internet, and the remote computer 1501 updating the customer information table stored in the remote database 1503. In addition, the POS prints a plastic custom ID card with the customer's unique ID printed on the front of the card as shown by step 2037. The custom ID card includes an encoded magnetic strip that allows the customer to quickly enter his or her unique ID in a foot measuring device for future footwear purchases rather than having his or her foot measured again.

Portions of the invention may be conveniently implemented using conventional general purpose computers or microprocessors programmed according to the teachings of the present invention, as will be apparent to those skilled in the computer art. Appropriate software can be readily prepared by programmers of ordinary skill based on the teachings of the present disclosure, as will be apparent to those skilled in the software art.

FIG. 21 illustrates a computer system 2101 upon which an embodiment according to the present invention may be implemented. Computer system 2101 includes a bus 2103 or other communication mechanism for communicating information, and a processor 2105 coupled with bus 2103 for processing the information. Computer system 2101 also includes a main memory 2107, such as a random access memory (RAM) or other dynamic storage device (e.g., dynamic RAM (DRAM), static RAM (SRAM), synchronous DRAM (SDRAM), flash RAM), coupled to bus 2103 for storing information and instructions to be executed by processor 2105. In addition, main memory 2107 may be used for storing temporary variables or other intermediate information during execution of instructions to be executed by processor 2105. Computer system 2101 further includes a read only memory (ROM) 2109 or other static storage device (e.g., programmable ROM (PROM), erasable PROM (EPROM), and electrically erasable PROM (EEPROM)) coupled to bus 2103 for storing static information and instructions for processor 2105. A storage device 2111, such as a magnetic disk or optical disc, is provided and coupled to bus 2103 for storing information and instructions.

The computer system 2101 may also include special purpose logic devices (e.g., application specific integrated circuits (ASICs)) or configurable logic devices (e.g., generic array of logic (GAL) or reprogrammable field programmable gate arrays (FPGAs)). Other removable media devices (e.g., a compact disc, a tape, and a removable magneto-optical media) or fixed, high density media drives, may be added to the computer system 2101 using an appropriate device bus (e.g., a small computer system interface (SCSI) bus, an enhanced integrated device electronics (IDE) bus, or an ultra-direct memory access (DMA) bus). The computer system 2101 may additionally include a compact disc reader, a compact disc reader-writer unit, or a compact disc juke box, each of which may be connected to the same device bus or another device bus.

Computer system 2101 may be coupled via bus 2103 to a display 2113, such as a cathode ray tube (CRT), for displaying information to a computer user. The display 2113 may be controlled by a display or graphics card. The computer system includes input devices, such as a keyboard 2115 and a cursor control 2117, for communicating information and command selections to processor 2105. The cursor control 2117, for example, is a mouse, a trackball, or cursor direction keys for communicating direction information and command selections to processor 2105 and for controlling cursor movement on the display 2113. In addition, a printer may provide printed listings of the data structures shown in FIGS. 19a, 19b and 19c, or any other data stored and/or generated by the computer system 2101.

The computer system 2101 performs a portion or all of the processing steps of the invention in response to processor 2105 executing one or more sequences of one or more instructions contained in a memory, such as the main memory 2107. Such instructions may be read into the main memory 2107 from another computer-readable medium, such as storage device 2111. One or more processors in a multi-processing arrangement may also be employed to execute the sequences of instructions contained in main memory 2107. In alternative embodiments, hard-wired circuitry may be used in place of or in combination with software instructions. Thus, embodiments are not limited to any specific combination of hardware circuitry and software.

As stated above, the system 2101 includes at least one computer readable medium or memory programmed according to the teachings of the invention and for containing data structures, tables, records, or other data described herein. Stored on any one or on a combination of computer readable media, the present invention includes software for controlling the computer system 2101, for driving a device or devices for implementing the invention, and for enabling the computer system 2101 to interact with a human user, e.g., a customer. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 2105 for execution. A computer readable medium may take many forms, including but not limited to, non-volatile media, volatile media, and transmission media. Non-volatile media includes, for example, optical, magnetic disks, and magneto-optical disks, such as storage device 2111. Volatile media includes dynamic memory, such as main memory 2107. Transmission media includes coaxial cables, copper wire and fiber optics, including the wires that comprise bus 2103. Transmission media may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 2105 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 2101 may receive the data on the telephone line and use an infrared transmitter to convert the data to an infrared signal. An infrared detector coupled to bus 2103 can receive the data carried in the infrared signal and place the data on bus 2103. Bus 2103 carries the data to main memory 2107, from which processor 2105 retrieves and executes the instructions. The instructions received by main memory 2107 may optionally be stored on storage device 2111 either before or after execution by processor 2105.

Computer system 2101 also includes a communication interface 2119 coupled to bus 2103. Communication interface 2119 provides a two-way data communication coupling to a network link 2121 that is connected to a local network (e.g., LAN 2123). For example, communication interface 2119 may be a network interface card to attach to any packet switched local area network (LAN). As another example, communication interface 2119 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 2119 sends and receives electrical, electromagnetic or optical signals that carry digital data streams representing various types of information.

Network link 2121 typically provides data communication through one or more networks to other data devices. For example, network link 2121 may provide a connection through LAN 2123 to a host computer 2125 or to data equipment operated by a service provider, which provides data communication services through an IP (Internet Protocol) network 2127. LAN 2123 and IP network 2127 both use electrical, electromagnetic or optical signals that carry digital data streams. The signals through the various networks and the signals on network link 2121 and through communication interface 2119, which carry the digital data to and from computer system 2101, are exemplary forms of carrier waves transporting the information. Computer system 2101 can transmit notifications and receive data, including program code, through the network(s), network link 2121 and communication interface 2119.

FIGS. 22-24 show another implementation of a shoe system in accordance with the present invention. The embodiment of FIGS. 22-24 is preferably implemented on a scanning type measuring station such as that described with respect to FIGS. 16 and 17 above. However, any suitable measuring station may be used. Moreover, U.S. Pat. No. 5,195,030, U.S. Pat. No. 5,123,169, U.S. Pat. No. 5,128,880, U.S. Pat. Nos. 5,206,804 and 5,216,594, the entire contents of each of which is incorporated herein by reference, describe specific methods and systems for implementing one or more steps of FIGS. 22-24. Still further the features and elements of FIGS. 22-24 can be implemented or combined with any embodiment of the invention described herein.

FIG. 22 is a flow chart showing the steps for obtaining information relating to a customer's foot. The flow chart shows only information collection with respect to the left foot, however, right foot information collection is done in a similar fashion to that described for the left foot, although the information collected for the right and left foot is typically different. As seen in FIG. 22, the process begins with setting a language at the foot measuring station. Language selections may be English, Spanish, or any other language. In step 2203, the foot is scanned in a sitting position and also in a standing position.

In the embodiment of FIG. 22, both feet are placed on the foot scanner in both the sitting and standing position and the measuring system separates the analysis of the individual feet. As also seen in step 2203, the scanner is equipped to collect weight information for the customer in the standing position. The embodiment of FIG. 22 takes a complete weight of the customer as they stand on the plexiglass that is above the scanner for use in pressure points of the foot as will be described below. Specifically, the scanner is equipped with an extremely thin weight sensor of approximately 0.008 inches thick, positioned on the plexiglass of the scanner. This allows the scan detectors and the sensors themselves from pushing the scan sheet too far away from the foot so that foot to scanner active elements are minimized. That is, the weight sensor is provided as a thin sheet so that the foot remains close to the optical scanner to maintain accuracy of the foot scan. In one embodiment, the weight sensor uses a sensor and detectors from TekScan with special applications circuit electronics to read the detectors, combine them, and adapt the weight sensing feature to a foot measuring devices.

In step 2205, the foot image obtained is enhanced and/or smoothed to remove dust, smudges and/or other anomalies. While conventional image correction used for scanning documents, for example, provides an erode procedure, which means the system will substract pixels that are not next to other pixels, and would further perform a dilate function from the eroded pixel count. The present inventors have recognized that the erode and dilate functions can be somewhat unpredictable when dealing with a foot scan. For example, toes might have their own individual pad area that is not very large but is associated with a much larger aspect of the foot; classic erode and dilate image correction will lose a few pixels around the toes and will probably dilate around the body of the foot, which is going to start disturbing the accuracy of the scanned dimensions. Thus, the embodiment of FIG. 22 performs lossless image correction that does not substantially change signals that are valid. For example, lossless image correction will not lose a signal relating to the pad print of the customer's little toe, which may be quite small from a signal point of view. Such lossless image correction is a good way to modify the foot scan without destroying scan information.

In step 2207, the system performs a count of the active pixels in the scan, including a high pressure count and a low pressure count. In this step, the edge of the customer's foot to the center of the foot is mapped out in relative pressures. The relative pressures are fed back to the scanner by how much blood is pushed out of the skin surface and how much is contacting the scanner plate. Thus, the scanner can detect relative pressure. According to one aspect of the present invention, this relative pressure can be used to calculate an amount of pressure per unit area of the foot as will be further described below. In step 2209, TWAC foot measurements are taken. As seen in FIG. 22, step 2209 includes finding Heel width in millimeters, locating a heel back edge in x,y coordinates, locating a Heel centroid in x,y coordinates, locating toe centroids in x,y coordinates and finding the longest toe in x,y coordinates. Also included is determining the foot length in mm, finding the 1^{st} through 5^{th} metatarsal heads in x,y coordinates, finding a center line of the foot using a pair of x,y coordinates, locating the medial and Lateral edge of foot in x,y coordinates, locating the T point in x,y coordinates, locating T length heel to T point in millimeters and measuring an arch depth and height sensor using an array of x y z coordinates. Also included is determining an arch shape descriptor (curve fitting), a foot type determination (for example, type 1 or 2 or 3), determining a curve medial triangle in degrees, determining a curve lateral triangle in degrees and determining a curve last zone (for example zones 1-6). One implementation of steps 2207 and 2209 are described in one or more of U.S. Pat. No. 5,195,030, U.S. Pat. No. 5,123,169, U.S. Pat. No. 5,128,880, U.S. Pat. Nos. 5,206,804 and 5,216,594, which are incorporated herein by reference.

According to one aspect of step 2209, differential pressures obtained from step 2207 are used to locate the second, third and fourth metatarsal heads and/or then the phalanges tip of the toes. In one embodiment the system actually targets and independently locates by X, Y coordinates the center of the toe pads where they contact the scanner surface. This type of mapping allows building a three-dimensional skeletal drawing of the customer's foot in terms of weights of bones from each of these key areas to avoid the metatarsal head at the bone lane. For example, from metatarsal head to the tip of toe is a bone lane; the phalange lane. The system of FIG. 22 allows the assembly of a biomechanical working dimensional model process to allow modeling of how flexible the foot is because the data obtained provides knowledge of how much a foot elongates and twists and turns. This provides a very powerful tool for not only fitting a shoe in a retail setting, but also keeping the shoe fit as the wearer performs an activity such as running, jumping etc.

In one embodiment, step 2209 includes determining an arch type based on whether the wearer's arch came beyond the midline, up to the midline or it didn't come across the foot at all in terms of the contact area to the center of the arch; for example, a Type I—High Arch, Type II—Standard Arch, Type III—Flat Arch configuration. However, the present inventors have recognized that this system is limited because it is not shape dependent and it is not necessarily height dependent; it is primarily the zone of contact. In another embodiment, the system actually describes the shape that a foot arch takes, whether it's a classic C-shape, elliptical, chopped elliptical, truncated elliptical, truncated circle, totally flat, triangular. Footwear components may be associated with these arch shapes to provide a high level of customization for the arch support and the shoe. For example, a rear arch piece can be a smooth arch shape, the mid arch can be a little squarish-type shape and the forefront arch can a cape cod shape. In describing the shapes with an incremental line drawings, (for example, one millimeter increments), the present invention can take a straight line segment and describe that shape. It's very efficient in terms of software coding, and allows the present invention to mimic the arch much closer than any conventional method has done before.

In step 2211, the system establishes the foot topology, the lines, areas of common depth elements and color scheme. In this step, the system groups areas of a common elevation with a particular color, and further groups areas of a common pressure with a particular color. This provides a color map of the topology of the foot. As a person stands on a surface, there's a lot of the person's foot that is in contact with the surface. So, even though when the foot is up in the air it would have a different topographical location, when it hits the surface it goes to the zero level of that surface. So, those surfaces that are in full contact are all zeros, but they have pressure differential lines drawn in. Those surfaces that are not in contact with the surface (such as the scanner plate) but can be seen in the foot scan, which is the rest of your foot, their lines refer to the topographical elevation changes to make it easy for the eye to connect the change and shape of the foot. The method of FIG. 22 enhances those pressure and elevation changes with colors so that if somebody looks at the foot scan, they can understand, for example, that all the red and yellows are high pressure points, all the blues are far away and the intermediate colors, the light greens and purple, those are transition where the foot is going from touching the reference surface to the areas that are very near the reference surface in terms of elevation.

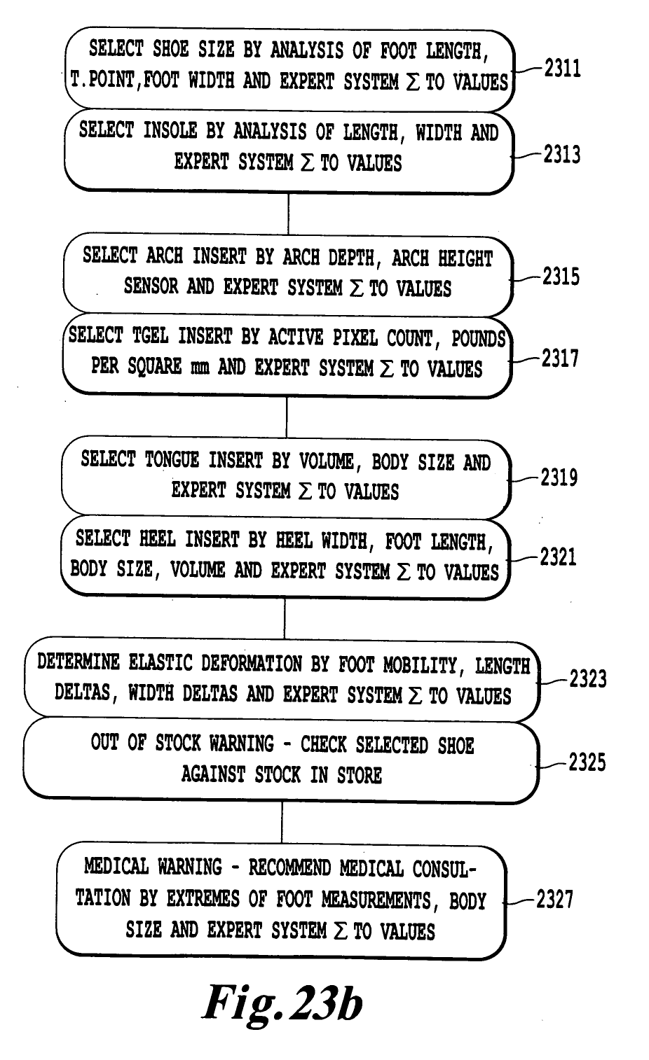

In step 2213, the data obtained by the optical scanner is saved and archived for use in the expert system foot analysis of FIG. 23. While not shown in FIG. 22, all foot measurements are performed on the customer's foot in both a sitting and standing position in order to obtain differential measurements that are useful in characterizing the customer's foot. For example, the foot topology establishing step 2211 is done in both positions to detect a change in those topographical areas in terms of shape and area between no weight on your foot or very little weight sitting and full body weight standing.

FIG. 23 shows a method for expert system foot analysis and shoe element selection criteria. Once the information relating to the customer's foot is obtained in the method of FIG. 22, a system according to the present invention can perform the method of FIG. 23 to identify footwear components to include with the shoe in order to customize the shoe to the measured foot. In steps 2301 and 2303, the foot elongation (length expansion) and foot spread (width expansion) is determined based on a ratio of the sit to stand measurements taken. As noted above, the sit and stand measurements can provide two data points from which extrapolations can be made. For example, if the foot spreads X amount under your body weight at 120 lbs. when you go running a system and method of the invention can determine that the runner is not only going 1G, but going 2G; there is actually 240 lbs hitting these areas. Similar extrapolations can be performed for what happens when a wearer plays tennis and turns a corner with 3Gs, for example. Once the data points are recorded, they can be applied to different models to determine the needs of a shoe for a particular person from whom data was collected.

Step 2305 includes determining a composite foot size and converting the composite foot size to a retailer size in US sizes, UK sizes etc. This step of determining a composite size is a response to a retailer's desire to sell a left and right shoe each having the same size. It's very unusual, statistically, for people have exactly the same left foot and right foot size. But for commercial reasons, a retailer would like to sell the same size for both feet. Therefore, step 2305 grabs a single frame shoe size, so to speak, from the retail stock, and then accommodates that with footwear components such as an insole thickness, arch piece and heel piece that allows that shoe to work best with the foot. For example, it is very easy for people to have a size or size-and-a-half difference between the left foot and right foot. According to the present invention, each foot can be provided with the same size and footwear components can be used to correct the volume, the arch, and/or the instep, for example, to get the foot in equal positions in the same vended size shoe. For example, if one foot is an 11.5 and one foot is an 11, a determination is made whether to buy the 11 and reduce the insole thickness, to go with the 11.5 and make the insole a little thicker. As another example, if there is a two size differences between feet (one is a size 9 and one is an 11), a 10.5 size shoe shell can be used and the insole and arch supports may be different so that each shoe fits comfortably on its respective foot. The composite foot size step 2305 provides a well thought out equation that builds a hierarchy of customer fitting elements that a retailer least wants to offend in determining a single shoe size for both feet.

In step 2307, foot mobility and flexibility is determined based on the number of high pressure points and a percent elongation sit-to-stand data, for example. In the embodiment of FIG. 23, mobility and flexibility is not only percent elongation and percent width, but it's also deterministic about how your arch changes shape. It is based on a determination of which zones of a person's foot increase in pressure relative to other zones as weight is applied to the foot. Because the overall body weight is captured, it can be determined, for example, if the weight underneath your first metatarsal substantially increases when the person stands on his or her feet. From this, it can be determined whether the person is not only just flexing but pronating which means your ankle rolls, your knee rolls to the medial or inside wall. As one example, if the measurements reflect an equal pressure increase across all the metatarsal heads from sitting to standing, it can be inferred that the foot it just flat spreading and is not rolling and not pitching. Thus, in the method of FIG. 23, not only are absolute pressure differences determined, but relative pressure differences, where the pressure goes upon standing and what the person's tendency, is are also determined. That is, it is not just determining a flexible foot, but actually showing what the person's lower leg and ankle are doing by the resultant forces in the foot. That is, the method of FIG. 23 provides additional information that leads in to mobility and flexibility of structures above what is actually measured.

In step 2309, body weight is factored to active pixel counts (for the multiple pressure zones) to determine pounds per square millimeter. This can be done to the overall foot and/or specific key foot zones in the heel and forefoot. As noted in the description of FIG. 22 above, the by obtaining overall body weight as well as relative pressure points on the foot (both sitting and standing), actual pressure per unit area can be determined in accordance with the present invention. Specifically, step 2309 applies the overall weight to the number of active pixels that are on the foot in order to obtain a true pixel pounds per square inch, pounds for square millimeter, etc. That is, based on the relative pressures mapped out on the foot, the system of the present invention can obtain absolute pressure mapping that includes not only a high pressure zone in the foot, but literally what the pounds per unit area is. For example, based on the absolute size of a foot, absolute areas that are in contact with the scanner plate and out of contact with the plate can be determined. This information can provide a smooth transition between those topographical lines that are no pressure to the one now is under pressure, and the system can calculate the total pressure that is reading under any toe, arch, heel, bone structure, etc.

Thus, the above described steps of FIG. 23 analyze characteristics of a person's foot based on actual measured data obtained in a process such as that described in FIG. 22. Steps, 2311, 2313, 2315, 2317, 2319 and 2321 provide the selection of various foot wear components based on the measurement and analysis steps performed. For example, step 2311 selects a shoe frame or shell size based on length, width T point values. Other elements are selected in steps 2313, 2315, 2317, 2319 and 2321 based on other measured (or non-measured) parameters of the foot. For example, once the frame size is selected (for example, group size 1, 2, 3, 4) an expert system according to the present invention will enter an iterative process where one or more footwear components such as the insole, arch support, and a gel piece are selected based on a person's information relating to foot characteristics. The expert system selects different combinations of components and analyzes the result relative to the measured and non-measured information obtained, in order to optimize a combination for the customer. This is performed for the left foot and for the right foot, and an analysis for both feet can be performed. Rather than a linear process, many scenarios are played out in a dynamic process that selects an optimal combination of components to fit the customer. As part of this process, non-measured preferences of a customer may be considered. The present inventors have recognized that what is measured tends to be related to what a customer prefers. For example, if a person is measured to have high pressure zones, the person will probably like a little bit of that in their shoe because they are used to it.

As one example of how the expert system actually matches up the user's foot with the various components, a foot may be measured at size 10.5, which is right at the dividing zone between group 3 and group 4 shoe shell, for example. So for length the group 3 shoe shell may be given a “5” score and the group 4 shoe a “3” score. For selection of the insole, because insole is technically linked to width, if the measured width is medium, then medium width insole will be given a “5” while a narrow gets “2” score wide gets a “3” score (wide may get a “2” score also, depending on actual measurements. Next, if the person's arch is measured as exactly an X configuration, an arch support component having this configuration gets a “5” score and the half X configuration gets a “3” score.

With these ratings of different components given, the expert system may determine that the person's standing position scan shows that the person's foot elongates to an 11.5. This indicates that a lot of pressure is being placed in the toe area and the group 4 shoe may jump up in score and the group 3 score retards a little bit. If a group 4 shoe shell (larger length and girth is favored, it may need to be accompanied by a little bit thicker insole and so the insole score changes. Thus, as each characteristic of the wearer is considered, the scores for each footwear component are updated and a preferred combination will emerge. For most people, there is going to be a definite preference for the consumer when he goes into that particular combination. This is particularly true if the increments of variation in the shoe components are very small. The end objective of the expert system is to get the overall tension of the shoe to match the overall 3D structure of a person's foot in its fully dynamic configuration; standing, sitting, walking. This is best performed in an iterative engine rather than a simple category assignment such as that discussed in FIGS. 19a and 19b. Moreover, as discussed above, the expert system can take into consideration not only measurement data but also non-measurement data such as when the customer is sitting at measurement kiosk he or she might type into the kiosk that he prefers a stiffer arch or he is a very fast, heavy walker, heavy footed walker etc. The expert system of the present invention can take this information into consideration in selecting footwear components for a customer.

As seen in FIG. 23, the elastic deformation step 2323 may optionally be included in an embodiment of the invention. This step allows footwear components of a shoe to be constructed with different elastic deformation characteristics. In one embodiment, the conventional lace of a shoe may be diverted from the parallel lines of eyelets that close the shoe to a set of eyelets on another part of the upper, such as the arch area on the medial side. This allows the shoe upper to be pulled in a desired direction to conform to the wearer's foot. In another embodiment, the conventional laces can be separate from other laces that provide elastic deformation.

According to one embodiment, a particular pattern of lacing may provide a particular amount of spring rate or a particular amount of tension around the wearer's foot. When information is collected about going through the dynamics of running or jumping or playing tennis, there are certain areas that desirably are held tight and there are other areas that are desirably left loose to let the wearer's foot drift. By altering the lacing pattern, you can get differential deformation or aid one area to really hold tight because it would cause injury and let an area drift because it adds to comfort or actually allows the athlete to put his foot in a preferential position for hitting the backhand or striking the golf ball. This deformation can enable engineering of different deformation rates in the different areas of the shoe. In one embodiment, a user can lace down and grab that particular area with the lace to provide a shoe that's acting completely different than the same shoe laced down in a different pattern which is maybe skipping every third element or every second element or skipping a crucial element and not lacing around a particular extension area that another athlete does because he has either a different foot shape or a different rate of elongation when he plays that particular sport.

In still another embodiment of step 2323, a lace can be tied to an internal footwear component such as the metatarsal rise so as to change the impact response of such a component. Generally, the present invention contemplates using laces not only for closing the shoe, but to control the rotation of your foot in the upper of the shoe by changing the deformation, or the elastic deformation, by using the laces to grab different elements. The present inventors have recognized that relatively small forces applied to the side of the upper can be much more effective in customizing the shoe than are forces applied from the bottom of the shoe such as by modifying the sole assembly.

Step 2325 provides an out of stock warning if the combination of components selected by the expert system includes a component that is out of stock in the retail store. In one embodiment, the expert system may be consulted to select a different combination of available footwear components.

In step 2327, the expert system may conclude that the foot measured has unique features that warrant a medical warning. In particular the measuring station can recommend a medical consultation for a limited class of people that could benefit from a true medical diagnosis, which can aid in determining where collective elements could be placed to make the shoe fit and feel better. The expert system itself does not provide a diagnosis, but rather recommends that the customer seek one. In one embodiment, the practitioner could fit the customer with a custom orthotic made specifically for the shoe of the retailer or manufacturer system that referred the customer, as described above with respect to FIG. 20.

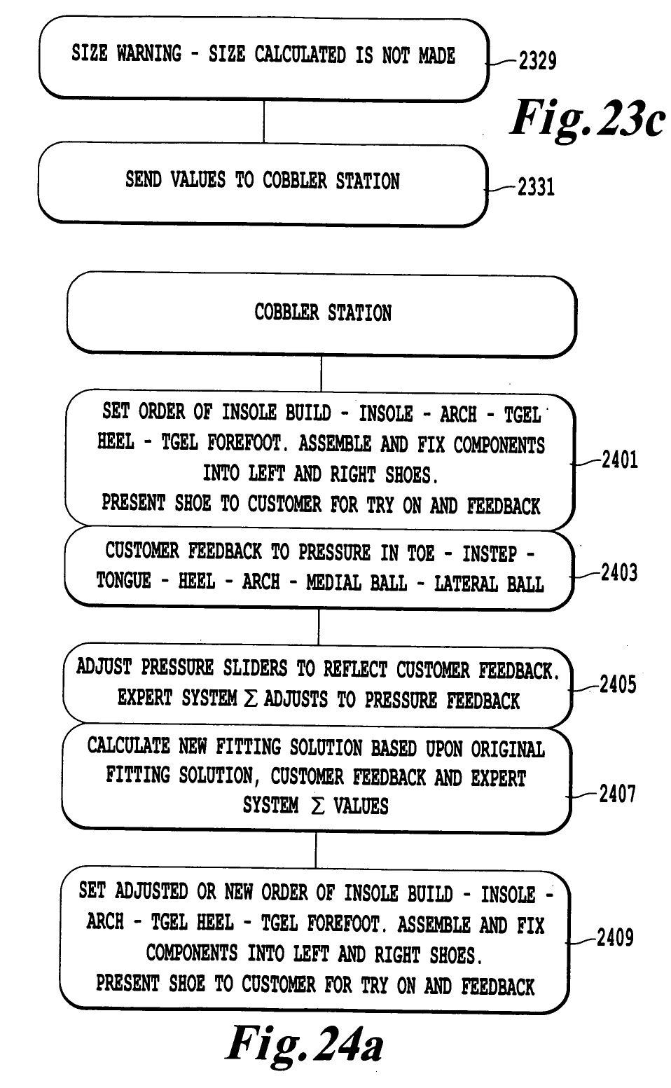

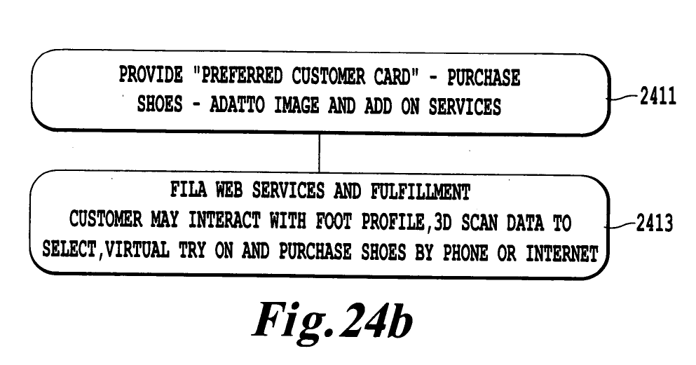

Still further, step 2329 may inform a sales person that the sizes calculated by the expert system are not available from the manufacturer. Once a preferred combination of footwear components is selected, this combination is sent to the cobbler station where the components are assembled as shown in FIG. 24.

As seen in FIG. 24, the combination of components is assembled in step 2401, and the customer tries on the shoe and provides feedback in step 2403. A retail sales representative may input the customer feedback to the expert system so that the system can adjust the rating values of components in step 2405, and calculate a new fitting solution as shown in step 2407. A new shoe is created and tried by the customer as shown in step 2409.

One aspect of the present invention provides an expansion members for expanding the sole assembly. The present inventors have recognized that this can aid in foot function as follows. One function of an ergonomic shoe, by virtue of it unique design, is to better adapt to diverse foot sizes present in the American population while keeping stock inventories minimal and at the same time adapting to the ever changing size and position of the feet throughout the day. The expansion members are designed to accommodate foot length, forefoot width and midfoot girth. The foot is a dual functioning appendage of the body which is designed to absorb kinetic loading which occurs during the heel strike or contact phase of the human gait cycle. At heel contact, the shoe's role is generally limited to providing good heel shock absorption along with a coaptive cradle capable of snugly gripping the heel prior to forefoot contact.

After the forefoot begins to load (the beginning of the midstance phase of human gait), the shoe plays a vital role in helping control the tri motion changes which occurs as the foot pronates or collapses against reactive floor resistance. A series of tri motion mechanical events occurs when the foot pronates, (as closed kinetic chain interlocking begins). At the same time, the midfoot (arch), lowers as the linear impaction of the body against the floor occurs, (Midtarsal Joint Pronation). In the act of foot pronation, the foot elongates as the arch collapses leading to a mechanical demand for the shoe to accommodate for this elongation.

At the same time, weight bearing along the plantar forefoot (Metatarsal Phalangeal Joints) causes the forefoot to widen or expand as the foot further adapts to the stress of body weight against the floor, (reciprocal or reactive kinetic stress loading). In one aspect of the invention, the inventors have designed the shoe(s) to expand to accommodate for these biomechanical positional point alignment changes) and structural (osseous or bony changes). This makes the shoe unique in it ability to adapt to the trimotion changes that occurs throughout the gait cycle.

To further create a unique custom demand in the shoe evolution, it should be able to accommodate for other anatomical foot characteristics. In addition, there are different types of feet which either accelerate or minimize further expansive changes of the feet. When we evaluate foot types, we have three primary foot characteristics, namely flexible feet (hypermobile) and rigid feet. Within these two categories, we have low arch (low girth) feet also known ad Pes Planus, normal arch feet or Pes Rectus and High arch high girth feet or Pes Cavus. These conditions add more demands for a shoe which has been answered in the inventors design.

Dorsal variety of strategically placed expansion members allow for forefoot widening and adaptive girth changes to occur. The outersole expansion member allows for foot elongation during the midstance phase of the gait cycle. These features makes the shoe(s) unique in its ability to prevent injuries, reduce fatigue, and reduce disease of the foot.

Obviously, numerous modifications and variations of the present invention are possible in light of the above teachings. It is therefore to be understood that within the scope of the appended claims, the invention may be practiced otherwise than as specifically described herein.

1. A method for providing a custom shoe to a consumer, comprising:
identifying at least one characteristic about a consumer that is present within the retail store, said at least one characteristic relating to the consumer's foot;
selecting a plurality of pre-fabricated footwear components based on said at least one characteristic;
assembling the plurality of prefabricated footwear components into a custom shoe that is customized to the consumer; and
presenting the custom shoe to the consumer before the customer leaves the retail store.

2. The method of claim 1, wherein said identifying comprises identifying at least one of a measured or a non-measured characteristic of the consumer.

3. The method of claim 2, wherein said measured characteristic comprises at least one of two dimensional foot measurements, three dimensional foot measurements, pressure point measurements, weight measurements, or gait length measurements.

4. The method of claim 2, wherein said non-measured characteristic comprises a medical diagnosis, biomechanical problems, demographic information, customer habit information, customer activity level information or customer preference information.

5. The method of claim 1, wherein said identifying comprises manually identifying at least one characteristic of the consumer.

6. The method of claim 1, wherein said identifying comprises using a foot measuring station to automatically identify a characteristic of the consumer.

7. The method of claim 1, wherein said selecting comprises manually selecting the plurality of pre-fabricated footwear components.

8. The method of claim 1, wherein said selecting comprises automatically selecting the plurality of pre-fabricated footwear components using a computer.

9. The method of claim 8, wherein said automatically selecting comprises printing a footwear prescription that lists the plurality of pre-fabricated footwear components in association with an identifier of the consumer.

10. The method of claim 9, further comprising storing said footwear prescription in association with the identifier in a master database.

11. The method of claim 10, further comprising updating the footwear prescription in response to feedback from the consumer.

12. The method of claim 1, further comprising providing a multimedia presentation to the consumer during said assembly step.

13. The method of claim 12, wherein said providing a multimedia presentation comprises providing an education primer to the consumer based on the characteristics of the consumer's foot.

14. The method of claim 1, further comprising:
obtaining feedback from the consumer about the custom shoe; and
changing at least one footwear component to adjust the custom shoe to address the consumer's feedback.

15. The method of claim 1, further comprising selling the custom shoe to the consumer before the consumer leaves the retail store.

16. The method of claim 15, wherein said selling comprises providing a purchase incentive to the consumer to induce the consumer to purchase the custom shoe.

17. The method of claim 16, wherein said purchase incentive is provided based on a purchase history associated with said consumer.

18. A method for providing a specialized orthotic, comprising:
identifying at least one characteristic about a consumer that is present within the retail store, said at least one characteristic relating to the consumer's foot;
determining from the at least one characteristic that the consumer could benefit from a specialized orthotic;
referring the consumer to a predetermined orthotics specialist who can prepare the specialized orthotic.

19. The method of claim 18, wherein said determining comprises automatically determining from the at least one characteristic that the consumer could benefit from a specialized orthotic.

20. The method of claim 19, wherein said determining comprises automatically determining from measured characteristics of the consumer that the consumer could benefit from a specialized orthotic.

21. The method of claim 19, wherein said determining comprises automatically determining from non-measured characteristics of the consumer that the consumer could benefit from a specialized orthotic.

22. The method of claim 19, wherein said predetermined orthotics specialist is an entity under contract with an entity referring the consumer.

23. The method of claim 19, further comprising said predetermined orthotics specialist preparing a specialized orthotic that is uniquely adapted to fit in a predetermined shoe type.

24. The method of claim 23, wherein said specialized orthotic is uniquely adapted to fit in a shoe type provided by an entity referring the consumer.
